(19) United States
(12) Patent Application Publication
(10) Pub. No.: US 2026/0351899 A1
(43) Pub. Date: Nov. 5, 2026

(54) FLAT HIGH CURRENT ELECTRICAL PLUGS AND CONNECTORS

(71) Applicant: Hubbell Incorporated, Shelton, CT (US)

(72) Inventors: William Dietz, Branford, CT (US); Thomas Scanzillo, Monroe, CT (US); Denny Lo, Bethlehem, CT (US); Roy Itzler, Orange, CT (US)

(21) Appl. No.: 19/697,011

(22) Filed: Jun. 3, 2026

Related U.S. Application Data
(63) Continuation of application No. PCT/US2025/031546, filed on May 30, 2025.
(60) Provisional application No. 63/654,526, filed on May 31, 2024.
(60) Provisional application No. 63/744,553, filed on Jan. 13, 2025.

(51) Int. Cl. H01R 13/629; H01R 13/631

(52) U.S. Cl. CPC H01R 13/62933; H01R 13/631

(57) ABSTRACT

An electrical connector system that reduces the insertion and extraction forces of male electrical connectors into female electrical connectors and provide greater conductivity to minimize thermal energy generated from electrical contacts under load is provided. In one implementation, an electrical connector includes a male plug and a female connector, wherein the male plug has multiple conductor pins extending therefrom, and wherein the multiple conductor pins are arranged in a substantially linear configuration. The female plug has multiple receptacles configured to receive the multiple conductor pins of the male plug. The electrical connector also includes a first multi-conductor cable extending from the multiple conductor pins of the male plug, wherein the first multi-conductor cable has a relatively flat configuration that gives the first multi-conductor cable a relatively small bend radius.

### PRIORITY

This application is a continuation of International Application No. PCT/US2025/031546, filed May 30, 2025, which claims priority to U.S. Provisional Patent Application Ser. No. 63/654,526 filed May 31, 2024, and U.S. Provisional Patent Application Ser. No. 63/744,553 filed Jan. 13, 2025 the contents of which are hereby incorporated by reference in their entirety.

### FIELD

The present disclosure relates to electrical connectors.

More particularly, the present disclosure relates to latching features for reducing the effort needed for manually engaging and disengaging male and female components and an in-line arrangement of pins for reducing a bending radius.

### BACKGROUND

Electrical connectivity devices, such as electrical connectors, are prevalent anywhere power from a source must be carried through wires for power delivery to equipment and devices. Commonly encountered electrical connectors include so-called “pin-and-sleeve” connectors. As will be appreciated by one or ordinary skill in the art, pin-and-sleeve connectors typically comprise a male end have elongated “pins” that connects to a female “sleeve” comprising receptacles for the pins and having electrical contacts therein. With this configuration, the conductive portion of the pins can be fully encapsulated and insulated upon insertion to provide an internal electrical connection while protecting a user from inadvertent contact with the conductive pins. As will also be appreciated, these connections are typically friction fit connections that are intended to hold the connectors together to prevent accidental separation while also allowing a user to mate and unmate the connectors by hand.

In today's environment, demand for higher amperage connectivity solutions is increasing. For example, data centers have a growing need for high amperage connectors. Artificial Intelligence (AI) and other technologies are driving servers and associated supporting equipment to consume more power. The conventional connectors available today to support these applications must be much larger than standard connectors and thus can be difficult for a user to mate and unmate. Specifically, while prior art pin-and-sleeve devices often utilize locking rings to maintain connection once they have been engaged, the engagement of male to female devices is typically done by hand. Typically, a considerable linear mating force is required to engage (and disengage) the conventional pin-and-sleeve connectivity devices. An increase for high amperage devices also results in a larger size of the electrical contacts, which forces these higher amperage devices to become larger and ultimately less ergonomically friendly to mate and unmate.

Currently 60 Amp pin-and-sleeve wiring devices are used in data centers. If data centers need at least 100 or 175 Amp devices in the future, the existing 100 Amp conventional round pin-and-sleeve wiring devices may be too large. It would be advantageous to have at least 175 Amp devices in the size of 60 Amp devices. Additionally, there is a need for form factors other than conventional round pin-and-sleeve wiring devices to facilitate handling and management of such high current devices.

### SUMMARY

Various examples of the present disclosure can overcome various of the aforementioned and other disadvantages associated with known connectors. For example, the present inventors recognized a need in the marketplace for connectivity devices that are easier to mate and unmate while maintaining the ability to hinder accidental decoupling. The present inventors also recognized a need for connected devices that run cooler than their predecessors. Cooler running connection solutions would aid in the cooling load that must be managed and mitigated with higher amperage operations.

Various embodiments of the present disclosure provide connectivity solutions that reduce insertion forces and/or extraction forces of male into female electrical connectors, thus minimizing the ergonomic burdens. The various embodiments provide other advantages and benefits. For example, another benefit of various embodiments is to produce male and female contacts with greater conductivity to minimize thermal energy generated from electrical contacts under load.

The present disclosure describes devices suitable for at least 175 Amps configured as linearly arranged pin-and-sleeve devices. The various disclosed embodiments enable compact size and thermal management for at least 175 Amp current rating devices. For example, sleeve contacts are provided with varying number of spring members within the female contact for reduced contact resistance. In one aspect, the shape of the male contact is configured to reduce mating force. In another aspect, high conductivity plating on contacts is utilized to reduce contact resistance. In a further aspect, contact material selection is selected for thermal management and compact size. In certain embodiments, an increased number of wire terminal screws are provided for reduced contact resistance and for redundancy in mission-critical applications. In various embodiments, novel contact shapes are provided to increase heat dissipation. In further embodiments, vents are provided in the sleeve contacts and/or in the wiring device housings to dissipate heat. In other embodiments, liquid cooling is utilized to dissipate heat. In yet other embodiments, unique keying is employed to prevent intermateability with traditional 60 A devices.

According to one aspect of various embodiments of the present disclosure there is provided various connectivity devices that make use of novel form factors, novel pin-and-sleeve configurations, and novel mechanical connection mechanisms that aid the ability to mate and unmate the devices with manageable effort.

According to one aspect of various examples of the present disclosure there is provided pin-and-sleeve connectors comprising a male connector and a female connector. The male connector includes at least one insertion pin of conductive material. The insertion pin has a full pin outside diameter and a tapered section positioned towards a distal end of the insertion pin. The female connector includes a sleeve having a sleeve inside diameter; wherein the sleeve inside diameter is larger than the full pin outside diameter; and wherein the sleeve is configured to receive the insertion pin to make an electrical connection.

In some embodiments, a spring element is configured as part of the female connector and has a spring inside diameter that varies as the spring element moves from a released position to an engaged position that creates electrical contact and provides a holding force for secure connection of the connector.

In some forms, the tapered section extends away from the distal end of the insertion pin a distance at least equal to one-half the full pin outside diameter. In other forms, the tapered section extends away from the distal end of the insertion pin a distance at least equal to the full pin outside diameter. In some forms, the tapered section has a taper angle of 1.5°+/−0.75°. In some embodiments, the pin includes a chamfered section positioned between the distal end and the tapered section.

In some forms, a silver plating or other plating is provided on parts or areas that contact each other to aid the electrical conductivity of the connector once engaged.

In addition, one implementation of an electrical connector comprising a male plug or connector having multiple conductor pins extending therefrom, where the multiple conductor pins are arranged on the male plug in a substantially linear configuration resulting in a substantially flat connector housing. The electrical connector also includes a female connector having multiple receptacles or sleeves configured to receive the multiple conductor pins of the male plug, i.e., the sleeves are arranged in a substantially linear configuration with a flat housing. Also, an individual conductor extends from each of the multiple conductor pins of the male plug, where multiple individual conductors have a relatively flat configuration that gives the multiple individual conductors a relatively small bend radius.

In some embodiments, the electrical connector may be configured to carry a high current of at least 175 Amps. The electrical connector may include a latching assembly having first and second parts arranged on the male and female connectors. The first part, for example, may include a) a pair of pivot pins for enabling the first part to pivot, b) a latch handle configured for providing leverage, and c) a pair of arcuate grooves for enabling engagement with a pair of pegs on the second part.

Furthermore, the electrical connector may be configured wherein each of the multiple conductor pins of the male plug includes one or more chamfered end sections for insertion into the multiple receptacles of the female connector. Each of the multiple receptacles of the female connector may include a conductive contact having multiple linearly oriented spring components configured for easy engagement and disengagement with the respective conductor pin of the male plug. The male plug and female connector, according to some embodiments, may each include a) vents for dissipating heat, and b) interconnected liquid-carrying conduits for dissipating heat. In some embodiments, the multiple conductor pins of the male plug and the corresponding multiple receptacles of the female connector may include one ground conductor, two neutral conductors, and two hot conductors, wherein the ground conductor may have a larger diameter compared to the neutral and hot conductors to enable a keying feature for the electrical connector.

According to one aspect of the present disclosure, an electrical connector is provided including a male plug having multiple conductor pins extending therefrom, the multiple conductor pins being arranged on the male plug in a substantially linear configuration; a female connector having multiple receptacles configured to receive the multiple conductor pins of the male plug; and a plurality of individual conductors, an individual conductor extending from each of the multiple conductor pins of the male plug, the plurality of individual conductors having a relatively flat configuration that gives the plurality of individual conductors a relatively small bend radius.

In one aspect, the electrical connector is configured to carry a high current of at least 175 Amps.

In another aspect, an electrical connector further includes a latching assembly having first and second parts arranged on the male and female connectors, wherein the first part includes: a) a pair of pivot pins for enabling the first part to pivot, b) a latch handle configured for providing leverage, and c) a pair of arcuate grooves for enabling engagement with a pair of pegs on the second part.

In a further aspect, each of the multiple conductor pins of the male plug includes one or more rounded end sections for insertion into the multiple receptacles of the female connector, and wherein each of the multiple receptacles of the female connector includes a conductive contact having multiple concentrically-oriented spring components configured for easy engagement and disengagement with the respective conductor pin of the male plug.

In one aspect, the male plug and female connector each include at least one of vents for dissipating heat and interconnected liquid-carrying conduits for dissipating heat.

In another aspect, the multiple conductor pins of the male plug and the corresponding multiple receptacles of the female connector include one ground conductor, one neutral conductor, and three hot conductors, and wherein the ground conductor includes a diameter large than diameters of the neutral and hot conductors to enabling a keying feature for the electrical connector.

In a further aspect, a position of the ground conductor prevents intermating of the male plug to a female connector with a different electrical rating.

In one aspect, an electrical connector further includes two or more springs elements disposed in each receptacle, the two or more spring elements providing holding force for said insertion pin and providing multiple areas of electrical contact.

In yet another aspect, an electrical connector further includes two or more springs elements disposed in each receptacle configured as a single spring, each of the two or more springs includes a first end and a second end with a convolution portion disposed therebetween, wherein a first end of a first spring is coupled to a second end of a second spring, the single spring disposed in the receptacle.

In a further aspect, the single spring is stamped from sheet material and configured in a C-shape, wherein the single spring is compressed into a cylindrical shape when disposed in a receptacle of the female connector.

In one aspect, an electrical connector further includes silver plating in at least said areas of said electrical contact.

In another aspect, an electrical connector further includes silver plating on at least interfacing surfaces between the male plug and female connector.

In still another aspect, the conductor pins and receptacles include a termination portion for receiving a conductor, the termination portion including an internally threaded surface to reduce contact resistance with the conductor.

In a further aspect, the conductor pins and receptacles include a termination portion including a cavity that receives a conductor and an inner surface of the cavity is configured with asperity points to create predictable points of contact between the inner surface of the cavity and the conductor.

In one aspect, the termination portion includes at least two apertures arranged circumferentially to the cavity, each aperture configured to receive a screw to secure the conductor in the cavity.

In another aspect, the screw includes a high strength copper alloy.

In a further aspect, the high strength copper alloy includes at least one of beryllium copper and copper titanium.

In still a further aspect, the conductor pins and receptacles include a copper alloy.

In another aspect, the copper alloy includes at least one of tellurium copper, chromium copper and zirconium copper.

According to one aspect of the present disclosure, a pin-and-sleeve electrical connectivity apparatus includes a male connector; an insertion pin of conductive material with a distal end and a proximal end configured as part of the male connector, the insertion pin having a full pin outside diameter; a tapered section of the insertion pin positioned towards the distal end of the insertion pin; a female connector; a sleeve configured as part of the female connector, the sleeve having a sleeve inside diameter; wherein the sleeve inside diameter is larger than the full pin outside diameter of the insertion pin; and wherein the sleeve is configured to receive the insertion pin to make an electrical connection.

In another aspect, the pin-and-sleeve electrical connectivity apparatus further includes a spring element configured as part of the female connector, the spring element having a spring inside diameter; wherein the spring inside diameter of the spring element in the released position is smaller than the full pin outside diameter of the insertion pin; and wherein the spring inside diameter of the spring element in the engaged position is at least as large as the full pin outside diameter of the insertion pin.

In another aspect, the pin-and-sleeve electrical connectivity apparatus further includes two or more springs elements configured as part of the female connector, said two or more spring elements providing holding force for said insertion pin and providing multiple areas of electrical contact.

In a further aspect, the pin-and-sleeve electrical connectivity apparatus further includes silver plating in at least said areas of said electrical contact.

In one aspect, the pin-and-sleeve electrical connectivity apparatus further includes a chamfered section positioned between the distal end and the tapered section.

In another aspect, the tapered section has a taper angle of 2.5°+/−2.0°.

In one aspect, the tapered section extends away from the distal end of the insertion pin a distance at least equal to one-half the full pin outside diameter.

In another aspect, the tapered section has a taper angle of 1.5°+/−0.75°.

In a further aspect, the tapered section extends away from the distal end of the insertion pin a distance at least equal to the full pin outside diameter.

According to another aspect of the present disclosure, a pin-and-receptacle electrical connectivity apparatus includes a male plug including a plurality of pins; an insertion pin of conductive material included among the plurality of pins, the insertion pin having a distal end and a proximal end configured as part of the male connector; a female connector including a plurality of receptacles; a sleeve receptacle included among the plurality of receptacles; a latch body hingedly affixed to one of the male plug or the female connector, the latch body including a clamping extension, an open boss receiving end, and a cradle section; a mating boss extending affix to the other of said male or said female connector; wherein in an engaged position the mating boss is in contact with the cradle section, and each one of the plurality of pins is fully inserted into a respective one of the plurality of receptacles.

In one aspect, the latch body defines a pivot pin opening to receive a pivot pin thereby allowing the latch body to hingedly rotate around the pivot pin.

In another aspect, the pin-and-sleeve electrical connectivity apparatus further includes a latch handle affixed to the latch body; said latch handle providing lever force to pull said male and female connectors into the engaged position.

In a further aspect, the pin-and-sleeve electrical connectivity apparatus further includes an arcuate latching groove section of the latch body positioned between the open pin receiving end and the cradle section and configured to receive said boss and draw said female and male connectors together as the boss travels the length of the arc during rotation of said latch body.

In one aspect, the boss is disposed on said female connector and is spaced a distance on said female connector to ensure complete insertion of said pins in said receptacles when said boss reaches the cradle section of said latch body hingedly disposed on said male connector to reach said engaged position.

In another aspect, the pin-and-sleeve electrical connectivity apparatus further includes a spring loaded plunger disposed in said female connector configured to push said male connector out and away from said female connector when said latch is released from said engaged position.

In a further aspect, the pin-and-sleeve electrical connectivity apparatus further includes at least one spring loaded butt contact.

In yet another aspect, the pin-and-sleeve electrical connectivity apparatus further includes at least one stacking boss on an upper surface of at least one of said male and female connector; and at least one stacking hole on a bottom surface of at least one of said male and female connector; whereby two or more of said pin-and-receptacle apparatus may be stacked by inserting a stacking boss of a first apparatus into a stacking hole of a second apparatus placed on top of said first apparatus; and whereby said first and second apparatus are stackable and held in a stacking arrangement only if said first and second apparatus are in the fully engaged position.

According to one aspect of the present disclosure an electrical connector includes a male plug having multiple conductor pins extending therefrom, the multiple conductor pins being arranged on the male plug in a substantially linear configuration; a female connector having multiple receptacles configured to receive the multiple conductor pins of the male plug; a latching receiver disposed on a surface of one of the male plug or the female connector; and a latching member disposed on a surface of the other of said male plug or said female connector; wherein in an engaged position the latching member is received by the latching receiver, and each one of the multiple conductor pins is fully inserted into a respective one of the multiple receptacles.

In one aspect, the latching receiver includes a pivoting latch that pivots about a pivot point formed on the surface.

In another aspect, the latching receiver further includes a spring that biases the pivoting latch into a first position.

In a further aspect, the latching receiver further includes a latching cover coupled to the surface to retain the spring and pivoting latch to the surface.

In still a further aspect, the latching member includes a ramp that guides the pivoting latch over a latching surface, wherein once over the latching surface, the spring pivots the pivoting latch into a second latched position.

According to another aspect of the present disclosure, a pin-and-shoe electrical connectivity apparatus includes a male portion of the pin-and-shoe electrical connectivity apparatus, the male portion including a male housing; a plurality of conductor pins extending from the male housing of the male portion; a ground conductor receiving hole in the male housing of the male portion configured to receive a ground conductor wire; a plurality of line receiving holes in the male housing of the male portion, each of the plurality of line receiving holes being configured to receive a line conductor wire; a female portion of the pin-and-shoe electrical connectivity apparatus, the female portion including a female housing; a plurality of female receptacle openings configured as part of the female portion, each of the plurality of female receptacle openings being configured to receive a respective one of the plurality of conductor pins; and a plurality of female conductor shoes, wherein each of the plurality of female conductor shoes is located within a respective one of the plurality of female receptacle openings; wherein each of the plurality of female conductor shoes is configured to make electrical contact with a respective one of the plurality of conductor pins in response to the male portion and the female portion being in the engaged position.

In one aspect, the pin-and-shoe electrical connectivity apparatus further includes at least one finger extension configured as part of the male housing; a ramp portion of the finger extensions; and at least one finger receiving hole configured as part of the female housing.

In another aspect, the pin-and-shoe electrical connectivity apparatus further includes a carriage piece located within the female housing; and one or more spring elements arranged to push the carriage piece away from the female conductor shoes with the pin-and-shoe electrical connectivity apparatus in a disengaged position.

In one aspect of the pin-and-shoe electrical connectivity apparatus, upon inserting the at least one finger extension into the at least one finger receiving hole, and pushing the female portion towards the engaged position, the ramp portion pushes the carriage piece against the one or more spring elements, causing each of the plurality of conductor pins to make electrical contact with a respective one of the plurality of female conductor shoes.

In a further aspect, the carriage piece includes at least one cooperating internal ramp in said at least one fingerer receiving hole engaging said ramp portion of said finger extension thereby pushing said carriage against said one or more spring elements during insertion of said at least one finger extension.

In one aspect, the pin-and-shoe electrical connectivity apparatus further includes a longitudinally extending ground pin having a proximal end disposed in said ground conductor receiving hole and extending on a distal end a distance further than the lateral extension of said conductor pins, whereby upon insertion of said male portion, the ground conductor enters a ground pin receiving opening in said carriage.

According to one aspect of the present disclosure, a pin-and-shoe electrical connectivity apparatus includes a rectangular male portion having a plurality of conductor pins; a rectangular female portion having a plurality of conductor pin receiving openings having a shoe contact therein, said shoe contact having an open top; a movable carriage member disposed in said female housing having a plurality of closing teeth positioned above a respective one of said shoe contacts; a carriage closing member on said male contact configured to cause said carriage member teeth to move and contact a respective conductor pin positioned in said respective shoe contact when said male portion is inserted into said female portion.

According to another aspect of the present disclosure, a pin-and-shoe electrical connectivity apparatus includes a generally round male portion having a plurality of conductor pins; a generally round female portion having a plurality of pin receiving openings having a shoe contact therein; a donut-shaped radially expanding carriage member disposed centrally in said female portion and configured to move said shoe contacts outwardly upon radially expansion; a plurality of conductor teeth closing appendages disposed in said female housing in an area adjacent to a respective shoe contact at an operative distance whereby radially expansion of said carriage electrically secures a respective conductor pin in a respective shoe contact; and a central post extending from said male portion and sized to insert into said orifice to cause radial expansion of said carriage to electrical secure said plurality of conductor pins in a respective shoe contact.

### BRIEF DESCRIPTION OF THE DRAWINGS

Various aspects and advantageous features of the present disclosure will become more apparent to those of ordinary skill when described in the detailed description of preferred embodiments and reference to the accompanying drawings, wherein:

FIG. 1A is a front view depicting a male plug of a high-current, relatively flat electrical connector, in accordance with various embodiments disclosed herein.

FIG. 1B is a front view depicting the male plug of the high-current, relatively flat electrical connector of FIG. 1A in comparison with a connector having a substantially round form factor, in accordance with various embodiments disclosed herein.

FIGS. 2A-2J illustrate various views of a latching assembly for holding a male plug in a female receptacle or connector of a high-current, relatively flat electrical connector, in accordance with various embodiments disclosed herein.

FIGS. 2I-2K illustrates a connectivity device with spring loaded contacts in accordance with various embodiments disclosed herein.

FIG. 2L illustrates a connectivity device with structure for stacking connectors in accordance with various embodiments disclosed herein.

FIGS. 2M-2R illustrate various views of the male plug shown in FIGS. 2A-2J, in accordance with various embodiments disclosed herein.

FIGS. 3A-3C illustrate side views of another latching assembly for holding a male plug in a female receptacle or connector of a high-current, relatively flat electrical connector, in accordance with various embodiments disclosed herein.

FIGS. 3D-3E illustrate exploded views of the male plug shown in FIGS. 3A-3C, in accordance with various embodiments disclosed herein.

FIG. 3F is a front view of the male plug shown in FIGS. 3A-3C, in accordance with various embodiments disclosed herein.

FIG. 3G is a cross-sectional view of the male plug shown in FIG. 3F taken along lines 3G-3G, in accordance with various embodiments disclosed herein.

FIG. 3H is a partial sectional view of FIG. 3G, in accordance with various embodiments disclosed herein.

FIG. 3I is a cross-sectional view of the male plug shown in FIG. 3F taken along lines 3I-3I, in accordance with various embodiments disclosed herein.

FIG. 3J is a top view of a latching assembly, in accordance with various embodiments disclosed herein.

FIG. 3K is a front view of the latching assembly, in accordance with various embodiments disclosed herein.

FIG. 3L is a cross-sectional view of the latching assembly shown in FIG. 3K taken along lines 3L-3L, in accordance with various embodiments disclosed herein.

FIG. 3M is a perspective top view of the female connector shown in FIGS. 3A-3C, in accordance with various embodiments disclosed herein.

FIG. 3N is a perspective view of a bottom of the female connector shown in FIGS. 3A-3C, in accordance with various embodiments disclosed herein.

FIG. 3O is a front view of the female connector shown in FIGS. 3A-3C, in accordance with various embodiments disclosed herein.

FIG. 3P is a cross-sectional view of the female connector shown in FIG. 30 taken along lines 3P-3P, in accordance with various embodiments disclosed herein.

FIG. 3Q is a cross-sectional view of the female connector shown in FIG. 30 taken along lines 3Q-3Q, in accordance with various embodiments disclosed herein.

FIG. 3R is a bottom view of the female connector shown in FIGS. 3A-3C, in accordance with various embodiments disclosed herein.

FIGS. 3S-3U illustrate cross-sectional side views of the latching assembly shown in FIGS. 3A-3R, in accordance with various embodiments disclosed herein.

FIG. 3V is a top perspective view of another female connector, in accordance with various embodiments disclosed herein.

FIG. 3W is a perspective view of a bottom of the female connector shown in FIG. 3V, in accordance with various embodiments disclosed herein.

FIG. 3X is a perspective view of the female connector shown in FIG. 3V with a shroud removed, in accordance with various embodiments disclosed herein.

FIG. 3Y is an exploded view of the female connector shown in FIG. 3V, in accordance with various embodiments disclosed herein.

FIG. 3Z is a top view of the female connector shown in FIG. 3V with a connector cover removed, in accordance with various embodiments disclosed herein.

FIG. 4A is a cutaway view depicting a pin-and-sleeve connectivity device with a tapered diameter insertion pin, in accordance with various embodiments disclosed herein.

FIG. 4B is a cutaway view depicting a pin-and-sleeve connectivity device with a reduced spring element engagement, in accordance with various embodiments disclosed herein.

FIGS. 4C and 4D are cutaway views depicting a pin-and-sleeve connectivity device with multiple springs in the insertion sleeve, in accordance with various embodiments disclosed herein.

FIG. 4E illustrates a side view of multiple springs integrated into a single device, in accordance with various embodiments disclosed herein.

FIGS. 4F and 4G illustrate pin tips with blended radii, in accordance with various embodiments disclosed herein.

FIG. 4H illustrates an insertion pin tip with fully rounded tip, in accordance with various embodiments disclosed herein.

FIG. 4I a perspective view of a half-round spring element for use in the insertion sleeve, in accordance with various embodiments.

FIG. 4J is a cutaway of a pin-and-sleeve connectivity device with opposing half-round spring elements in the insertion sleeve, in accordance with various embodiments.

FIG. 5A is a perspective view of a split sleeve contact, in accordance with various embodiments disclosed herein.

FIG. 5B is another perspective view of the spilt sleeve contact as shown in FIG. 5A, in accordance with various embodiments disclosed herein.

FIG. 5C is a cross-sectional view of the split sleeve contact as shown in FIG. 5A, in accordance with various embodiments disclosed herein.

FIG. 6 is an oblique view depicting a pin-and-sleeve connectivity device with silver plating on key surface areas, in accordance with various embodiments disclosed herein.

FIG. 7A is a perspective view of a conventional contact.

FIG. 7B is a perspective view of a multi-termination contact, in accordance with various embodiments disclosed herein.

FIG. 7C is a cross-sectional view of the contact shown in HG. 7B, in accordance with various embodiments disclosed herein.

FIG. 7D is a cross-sectional view of a contact with a threaded termination portion, in accordance with various embodiments disclosed herein.

FIG. 7E is an exemplary graph comparing temperature of a contact with no threads in a termination portion versus a contact with threads in a termination portion, in accordance with various embodiments disclosed herein.

FIG. 8A is a perspective view of a sleeve contact with heat sink, in accordance with various embodiments disclosed herein.

FIG. 8B is a front view of the sleeve contact with heat sink as shone in FIG. 10A, in accordance with various embodiments disclosed herein.

FIG. 9A is a perspective view of a sleeve contact with venting elements, in accordance with various embodiments disclosed herein.

FIG. 9B is a perspective view of another sleeve contact with venting elements, in accordance with various embodiments disclosed herein.

FIG. 10 is a front view of a male plug of a high-current, relatively flat electrical connector having a contact arrangement to dissipate heat, in accordance with various embodiments disclosed herein.

FIG. 11A is a perspective view of a high-current electrical connector with venting elements, in accordance with various embodiments disclosed herein.

FIG. 11B is a perspective view of a high-current electrical connector with a liquid cooling system, in accordance with various embodiments disclosed herein.

FIGS. 12A and 12B are side views of electrical connectors with a round form factor and relatively flat form factor, respectively, showing the differences in bend radius, in accordance with various embodiments disclosed herein.

FIG. 13A is a perspective view of a strain relief assembly of a round form factor electrical connector, in accordance with various embodiments disclosed herein.

FIGS. 14A-14D illustrate another strain relief assembly for a high-current, relatively flat electrical connector, where FIG. 14A is a perspective view, FIG. 14B is a top view, FIG. 14C is a side view and 14D is an exploded view, in accordance with various embodiments disclosed herein.

FIGS. 14E and 14F are different views of a water ingress prevention assembly of a high-current, relatively flat electrical connector, in accordance with various embodiments disclosed herein, where FIG. 14E a cross-section view of the connector shown in FIG. 14B taken along lines 14E-14E and FIG. 14F a cross-section view of the connector shown in FIG. 14C taken along lines 14F-14F.

FIGS. 15A and 15B are front views of male plugs of a high-current, relatively flat electrical connector illustrating different keying features, in accordance with various embodiments disclosed herein.

FIG. 16A is a perspective front view of a male plug of a high-current, relatively flat electrical connector, in accordance with various embodiments disclosed herein.

FIG. 16B is a top front view of a female receptacle of a high-current, relatively flat electrical connector adapted for connection with the male plug of FIG. 16A, in accordance with various embodiments disclosed herein.

FIG. 16C is a cross-sectional view of the female connector of FIG. 16B, in accordance with various embodiments disclosed herein.

FIGS. 17A and 17B are perspective views of another strain relief assembly having a panel mount design, in accordance with various embodiments disclosed herein.

FIGS. 18A-B are perspective views depicting a connectivity device with a pin-and-shoe connection, in accordance with various embodiments disclosed herein.

FIG. 18C is a cutaway side view of the pin-and-shoe connectivity device, in accordance with various embodiments disclosed herein.

FIG. 18D is a cutaway top view of the pin-and-shoe connectivity device, in accordance with various embodiments disclosed herein.

FIGS. 18E-F are cutaway front views of the pin-and-shoe connectivity device, in accordance with various embodiments disclosed herein.

FIG. 18G is a perspective view of an internal part of the female portion of connectivity device, in accordance with various embodiments disclosed herein.

FIG. 19 is a front cutaway view of a female portion of a round connectivity device.

It should be understood that the drawings are for purposes of illustrating the concepts of the disclosure and are not necessarily the only possible configuration for illustrating the disclosure. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as not to unnecessarily obscure the embodiment.

### DETAILED DESCRIPTION

The various exemplary embodiments disclosed herein provide connectivity devices with reduced insertion and extraction forces that are easier to mate and unmate. Some of the various embodiments provide connectivity devices with greater conductivity characteristics.

As used in this application, terms such as “front,” “rear,” “side,” “top,” “bottom,” “above,” “below,” “upwardly” and “downwardly” are intended to facilitate the description of the electrical connector according to the present disclosure and are not to be construed as limiting the structure of the electrical connector to any particular position or orientation.

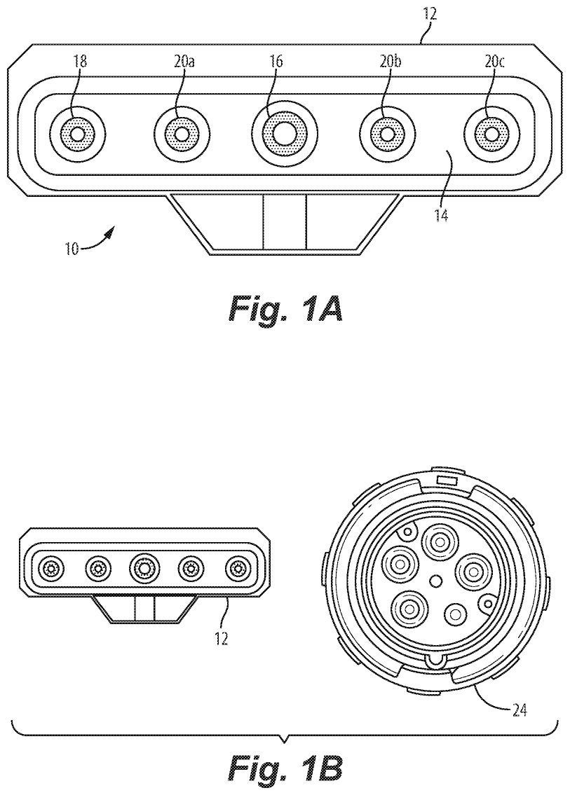

FIG. 1A is a front view depicting an embodiment of a male plug 12 of a high-current, relatively flat electrical connector 10. As shown in this embodiment, the male plug 12 has five conductors arranged in a substantially straight line extending from a face 14 of the male plug 12. The conductors include a ground pin 16 (or conductor), which may be positioned in the middle of the five in-line pins (or conductors). The male plug 12 also includes one neutral pin 18 and three power (or hot) pins 20a, 20b, 20c. The five pins may be arranged in any suitable configuration and are separated from each other to minimize short circuit situations.

FIG. 1B is a front view depicting an embodiment of the male plug 12 of the high-current, relatively flat electrical connector 10 of FIG. 1A in comparison with a connector 24 having a substantially round form factor. It may be noted that a female connector (not shown in FIGS. 1A and 1B) includes corresponding receptacles (or sleeves) for receiving the pins 16, 18, 20.

The “high-current” aspect of the high-current, relatively flat electrical connector 10 may refer to certain types of connectors and corresponding electrical cables that are configured for carrying high levels of current, such as 1 75 Amps or more. For example, in some scenarios, these high-current connectors and cables may be employed in data center environment where multiple high-power rack-mounted network elements are connected and powered. Naturally, with high currents, the temperature of the network elements is a concern that can be addressed by certain heat dissipating components, as discussed in the present disclosure. One advantage of arranging the electrical conductors in a linear manner, e.g., in a flat plug or housing, is that heat can be more dissipated than a round connector and cable that may arrange the conductors in a close-fit configuration, such a close-fit configuration connector 24 is shown in FIG. 1B. Also, a flat connector (e.g., the high-current, relatively flat electrical connector 10) may be connected to individual conductors rather than a bundled cable, which can be more easily maneuvered between rack-mounted network elements of the data center. That is, the “bend radius” of the individual conductors can be navigated around corners of network elements, racks, cabinets, shelves, etc. of the data center, as well as navigating cables through walls, under floors, etc. of the data center.

It may be noted that the electrical connector 10 orients the pins 16, 18, 20 and corresponding receptacles in a linear fashion to give the overall design a relatively “flat” shape. For example, in one embodiment, the relatively “flat” shape may be referred to as a rectangular cuboid. This arrangement includes many benefits. For example, conventional pins and sleeves rated for high currents may be too big for many data center applications. For example, a conventional round 100 A plug, e.g., connector 24 shown in FIG. 1B, may have a max Outside Diameter (OD) of about five inches. This may be too big to pass through a data center rack. Therefore, the embodiments of the present disclosure may be configured for more easily passing power cables through rack structures, from one network component to another, and inter-rack connections. That is, the present elements employ electrical contacts arranged in a row, rather than in a circular, tight-knit pattern. Again, the arrangement of the linearly oriented contacts results in a somewhat rectangular overall profile, as shown in FIG. 1A. It should be understood that this arrangement results in a system where network technicians setting up or maintaining a data center can more easily pass the connectors and cables through the racks.

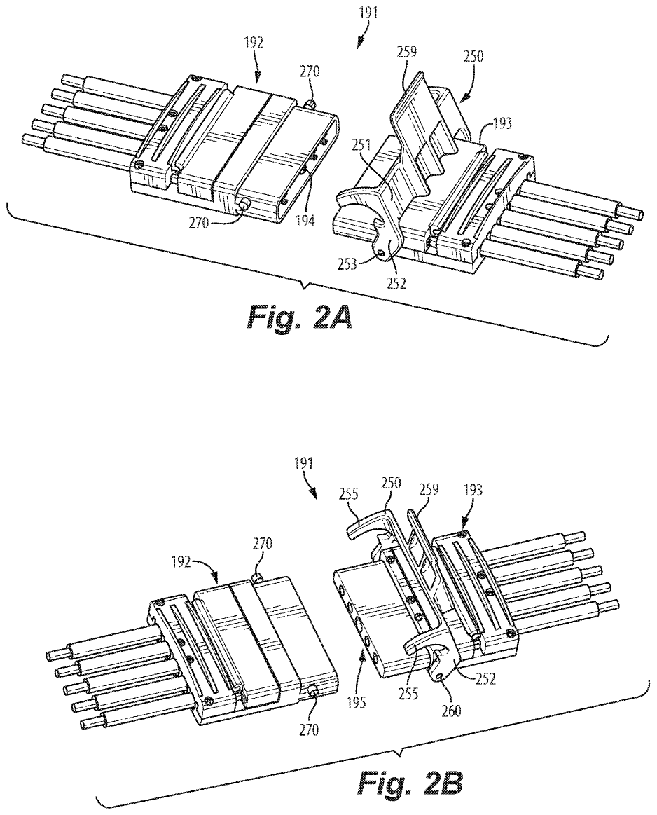

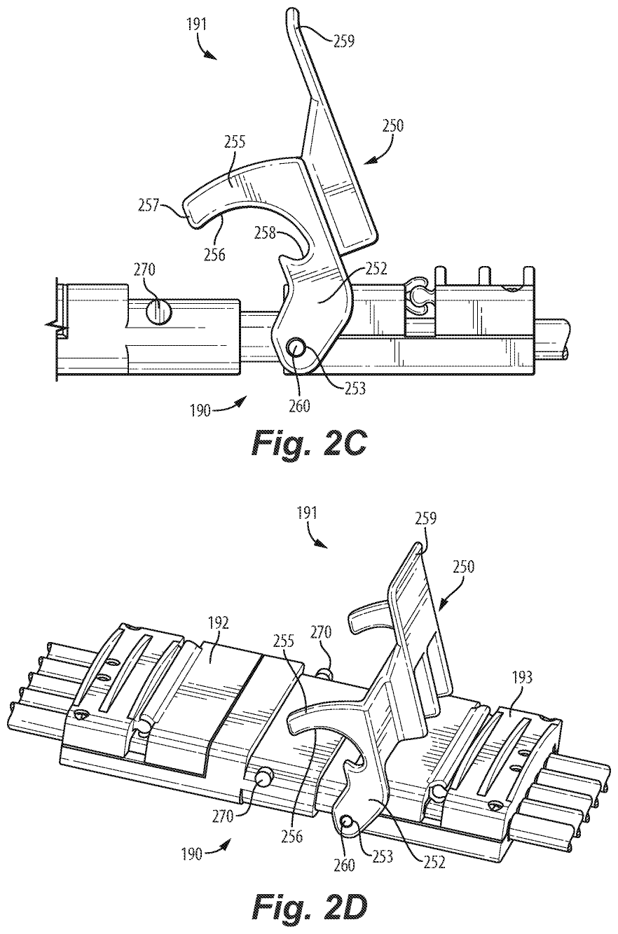

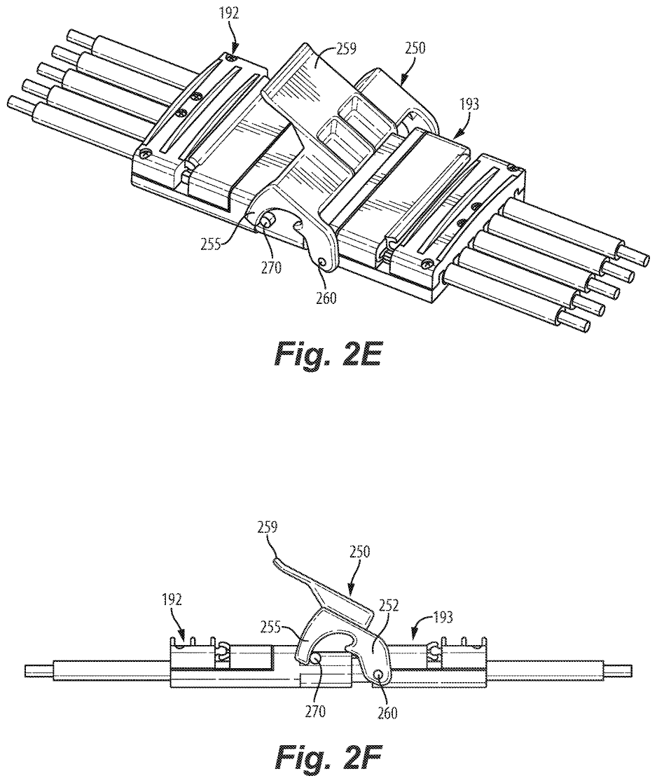

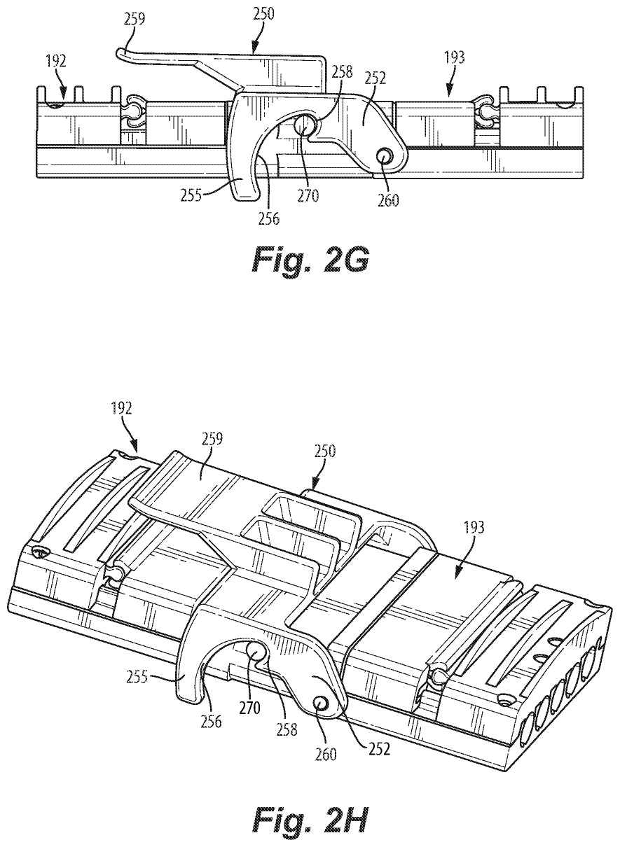

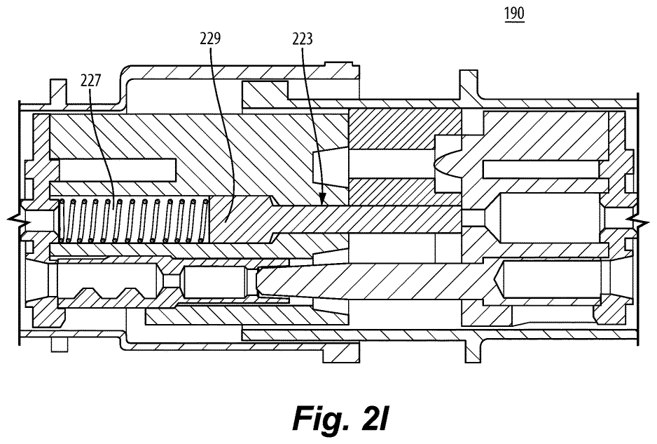

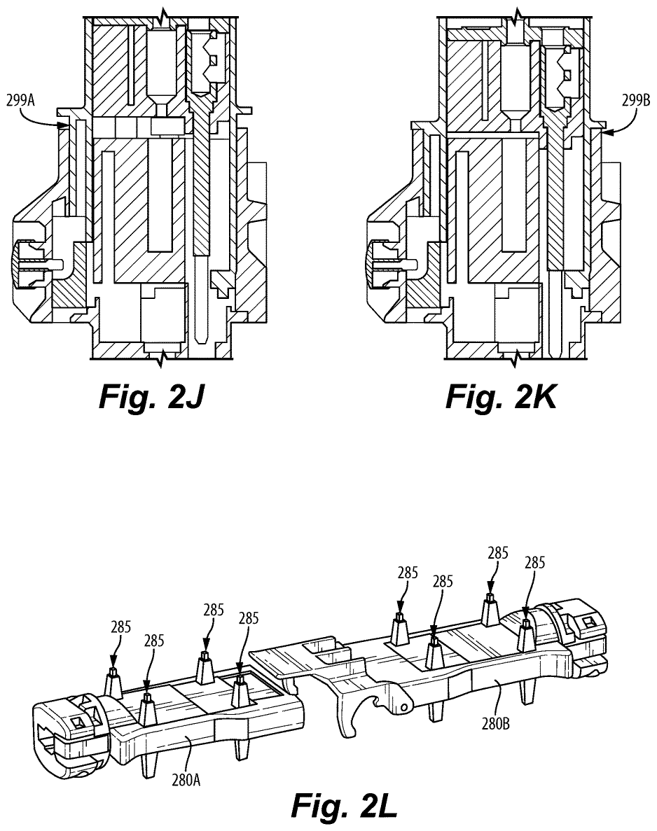

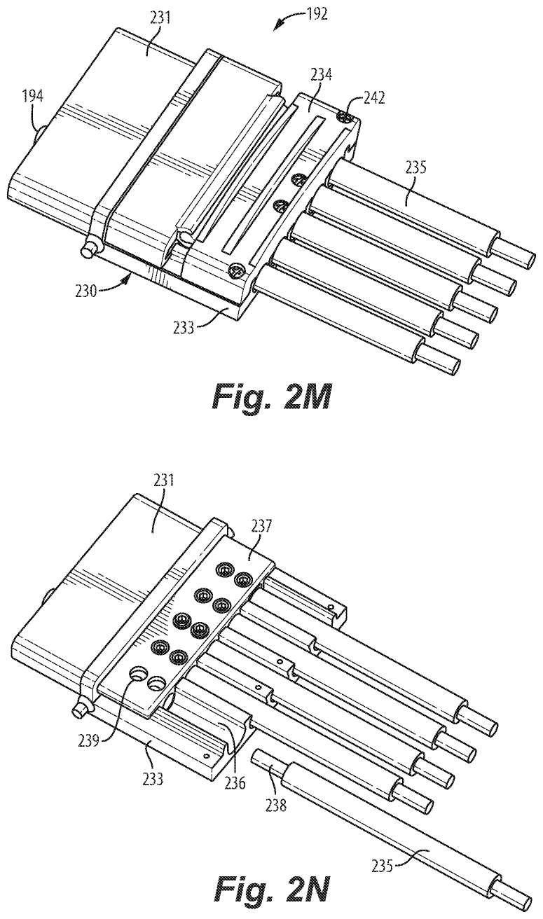

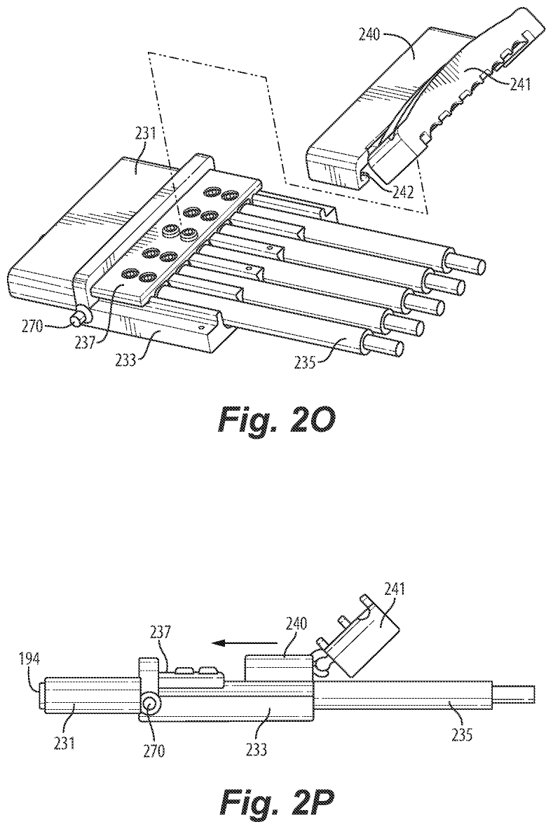

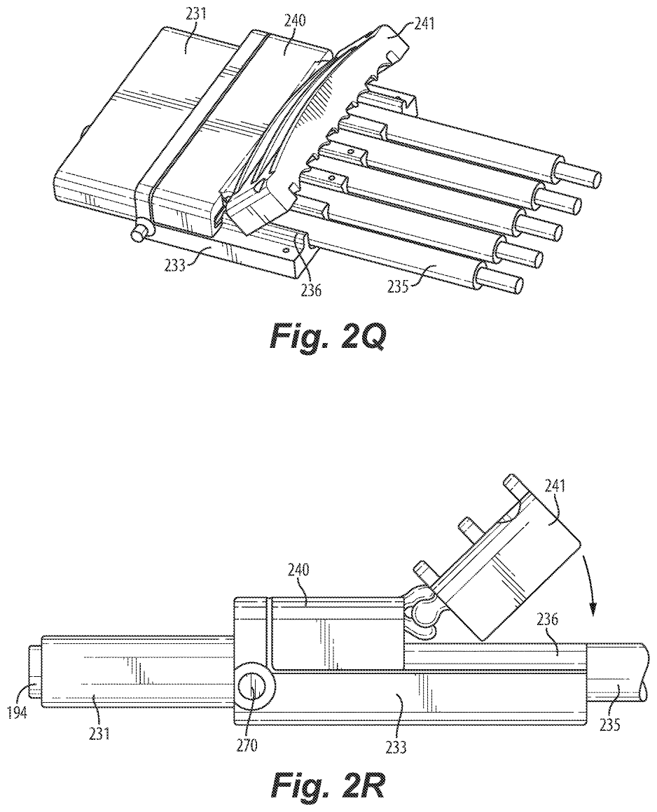

FIGS. 2A-2H illustrate various views of an embodiment of a latching assembly 190 for holding the male plug 192, e.g., male portion 12 of FIG. 1A in a female portion 193 (e.g., a female receptacle or connector) of the high-current, relatively flat electrical connector 10. As described herein, the latching assembly 190 includes a latch having a mechanical advantage (for the user) to ease the mating/unmating of the male and female portions. That is, the latching assembly 190 includes a latch member 250, which may be configured on the female portion 193, and pegs attached to the male portion 192. In other embodiments, the components of the latching assembly 190 can be reversed, whereby the latch member 250 is configured on the male portion 192 and the pegs are configured on the female portion 193.

It should be understood that the high-power, high-current connectors and cables used in various environments (e.g., in data centers) involve connecting large male portions 192 with large female portions 193, which may require a certain level of physical strength for the data center technicians. Therefore, to ease the physical burden with respect to connecting (e.g., mating, engaging, etc.) and disconnecting (e.g., unmating, disengaging, etc.) these connector portions, the latching assembly 190 provides a leverage arm that requires significantly less force to connect or disconnect. This can be an advantage from an ergonomic point of view.

A pivoting latch handle utilizes a cam surface to engage a peg (or pin) with a curved cam surface. The distance from a pivot point of the latch handle to the end of the latch handle is greater than the distance between the pivot point and the cam surface. As such, this creates a mechanical advantage to engage the male and female portions and lessens the force needed to engage and disengage the components and reducing the required effort from the technician.

As shown in FIGS. 2A-2H, configurations for electrical connectors are depicted for use in achieving various advantageous features of the present disclosure. With these embodiments, the connectivity devices use external latch member 250 to facilitate mating and unmating of connectors of the latching assembly 190.

FIGS. 2A-2H depict an embodiment of a flat connector 191 having a male portion 192 and a female portion 193, where FIGS. 2A and 2B illustrate the male and female portions unmated, FIGS. 2C and 2D illustrate the male and female portions partially mated, FIGS. 2E and 2F illustrate actuation of the latching assembly and FIGS. 2G and 2H illustrate the male and female portions fully mated. In the embodiment shown, male portion 192 include a plurality of pins 194 and the female portion 193 includes a plurality of respective female pin receptacles 195. In order to facilitate insertion of the pins 194 into the pin receptacles 195, the flat connector 191 is provided with a latch member 250. In some embodiments, the latch member 250 comprises a latch body 251 having a latch handle 259, a pivot point hub 252 having a pin opening 253, and a clamping extension 255 defining an arcuate latching groove 256 with an open pin receiving end 257 terminating in a cradle portion 258. As depicted, in some forms, these features are provided on both sides of the latch body 251.

The latch body 251 may be pivotably secured to either the male 192 or female 193 portions of the flat connector 191 (shown in FIG. 2A-H on the female portion for illustration purposes) by a pivot pin 260 extending through the pin opening 253 of the pivot point hub 252. In some forms, the latch body 251 is configured (as best shown in FIGS. 2C and 2D) to extend upright in the fully open position with the clamping extension 255 extending generally parallel with the connector body or pins. In some forms, the male portion 192 is provided with mating bosses 270 (e.g., pegs, pins) disposed in an area near entry of the pins 194. With this configuration, the latch body 251 may be rotated downwardly such that the pin receiving end 257 of the arcuate latching groove 256 provided in the clamping extension 255 engages the bosses 270 when partially rotated downwardly (as best shown in FIGS. 2E and 2F).

Once engaged by the clamping extension 255, further force provided to rotate the latch handle 259 to the closed position (best shown in FIGS. 2G and 2H) provides force on the bosses 270 that pulls the male 192 and female 193 portions together due to the curvature of the arcuate latching groove 256 until the bosses 270 reach the cradle portion 258 of the arcuate latching groove 256 and the latch handle 259 is fully engaged in the closed position and the connection is fully made.

As will be appreciated, with this configuration, it is the relative spacing of the bosses 270 and the arcuate latching groove 256 that allows the latch member 250 to be fully engaged and the connectors fully secured from the outside environment. As will also be appreciated, the physics of a fulcrum and lever allow for this connection to be made by a user at a fraction of what a traditional force-fit by hand would require securing the connector together.

In certain embodiments, such as that illustrated in FIGS. 2A-H, the latching connector uses a new form factor which is more compact in size than a pin-and-sleeve design (such as that depicted in FIG. 1A). While the embodiment shown employs contacts arranged in a row, the concepts of the present disclosure are equally applicable to other configurations.

In some embodiments, the lever action of the latching member 250 may result in difficulty separating the connector by hand. To facilitate disconnection, some latching connectors of the latching assembly 190 may be provided with spring loaded contacts. As shown in FIGS. 2I-2K, a connectivity device may be provided with spring loaded contacts comprising a spring-loaded plunger assembly 223 with spring member 227 and plunger 229.

In some forms, such as the depicted embodiment, a spring-loaded plunger assembly 223 is housed in the female connector which can push the male connector out and away from the female connector to make the unmating action easier. The spring loading applies force to ensure a good electrical connection between the male and female contacts. In operation, when a latch member 250 is released, the male device does not require much, if any, force to remove it since the spring-loaded plunger assembly 223 pushes the male and female connectors apart.

In alternative forms making use of spring-loaded butt contacts 299, the spring-loaded plunger assembly 223 may not be necessary. FIG. 2J shows an embodiment of a connectivity device with spring loaded contacts in the released position 299A. FIG. 2K shows a connectivity device with spring loaded contacts in the engaged position 299B. The use of spring-loaded butt contacts (as shown in FIGS. 2J and 2K), aids in reducing unwanted heat generation by maintaining a larger force between the engaged contacts.

One of ordinary skill in the art armed with the present specification will readily appreciate that the disclosure of these types of connectors lend themselves to other advantageous features. For example, various other embodiments may consolidate and simplify the latching action by tying together two or more latch members into a single activating lever. In addition, these new devices and form factors lend themselves to other uses. For example, as shown in FIG. 2L, a connectivity device may be provided with a structure for stacking connectors.

Specifically, with reference to FIG. 2L with an in-line form factor, adjacent devices can be stacked on top of each other to better organize cable management which is an important detail in data centers. In these embodiments, the housing sections 280A, 280B have bosses 285 on the top surface to engage bore holes (not shown) on the bottom surface to create uniform stacks of connectors. For example, when using latch members with handles on opposing surfaces, similar to those shown in FIGS. 2A-H, once the male and female connectors are in the engaged position, the receiving bore holes of one connectivity device of the housing sections 280A, 280B align with the bosses 285 of the connectivity device beneath it. This ensures the two housing sections 280A, 280B are properly mated (otherwise the bosses and bores will not align), and makes stacking the connectivity devices more organized.

One of ordinary skill in the art armed with the present specification will readily appreciate that the exemplary latching embodiments described above were provided for explanatory purposes and are not to be interpreted as limiting the present disclosure to any of the specific features, combinations, configurations, form factors, or other limitations described in connection with the embodiments depicted in the figures.

FIGS. 2M-2R illustrate various views of a housing 230 of male portion 192. The housing 230 includes a mating portion 231 configured for mating with a corresponding portion of the female portion 193 and a termination portion 232 configured for terminating a plurality of conductors 235 thereto. The termination portion 232 includes a conductor receiving portion 233 and a cover 234. As shown in FIG. 2N, the conductor receiving portion 233 includes a plurality of channels 236 and a retaining portion 237 disposed over the plurality of channels 236. To connect a conductor 235 to the conductor receiving portion 233, an exposed portion 238 of conductor 235 is disposed in an appropriate channel 236 and is secured in place via a fastener 239 disposed through the retaining portion 237. Once the conductors 235 are secured, the cover 234 is coupled to the conductor receiving portion 233.

The cover 234 includes a first cover portion 240 and a second cover portion 241 that is pivotally coupled to the first cover portion 240. The first cover portion 240 includes grooves 242 that are configured to mate with edges of the retaining portion 237. As shown in FIGS. 2O and 2P, the first cover portion 240 is slid onto the conductor receiving portion 233 until the first cover potion 240 fully engages the retaining portion 237. The second cover portion 241 is then pivoted, as shown in FIG. 2R, to cover the conductors 235. The second cover portion 241 is then secured in place via fasteners 242, as shown in FIG. 2M.

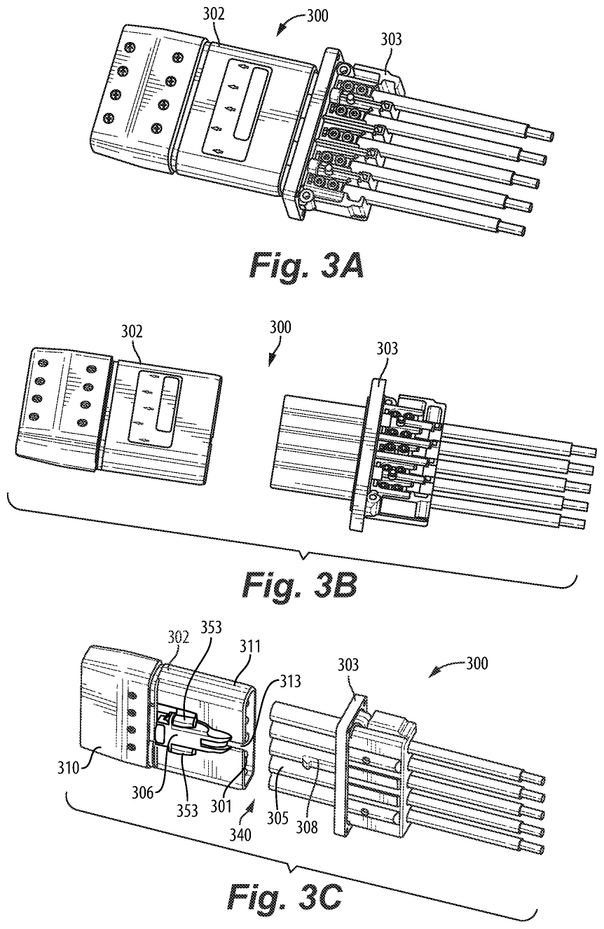

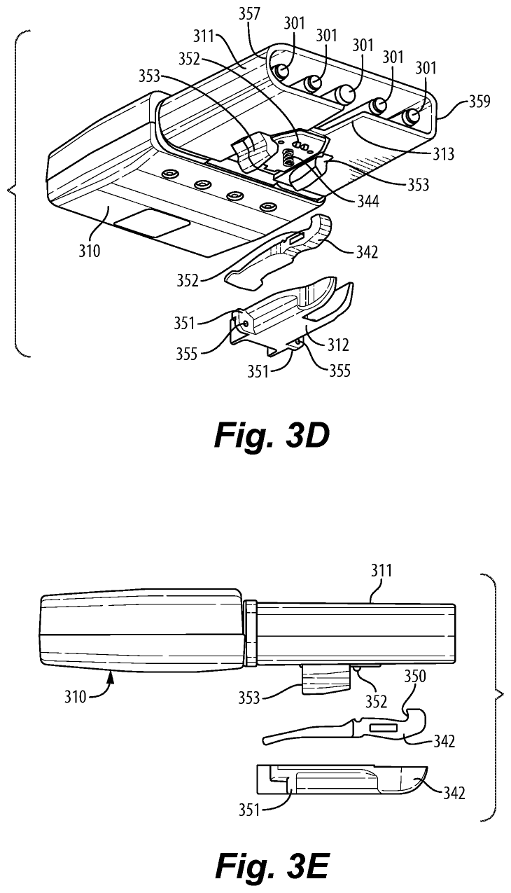

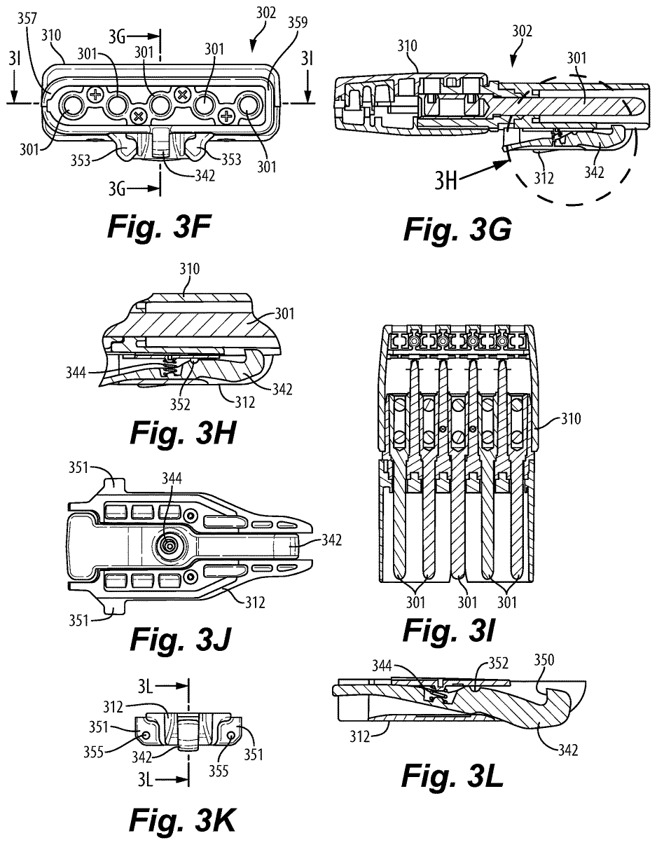

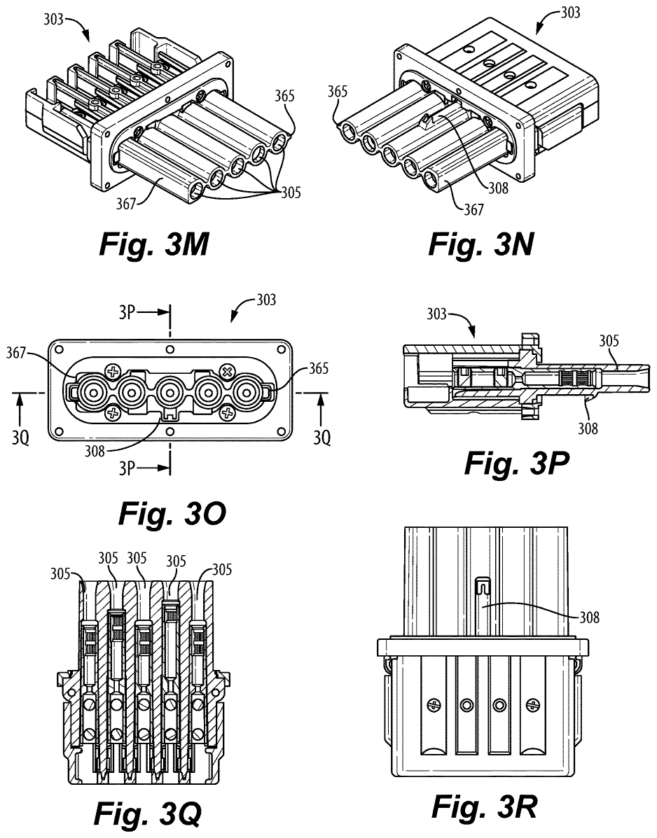

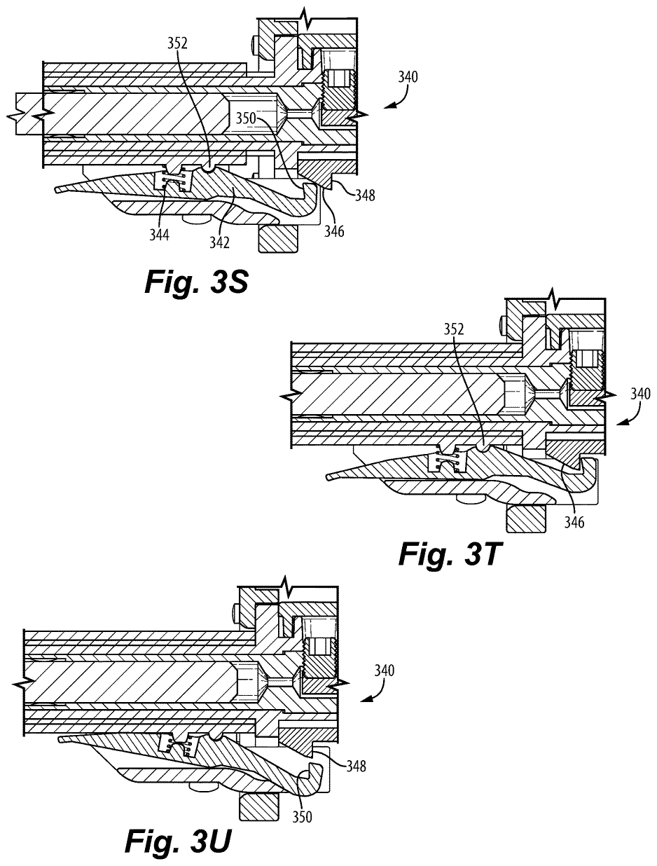

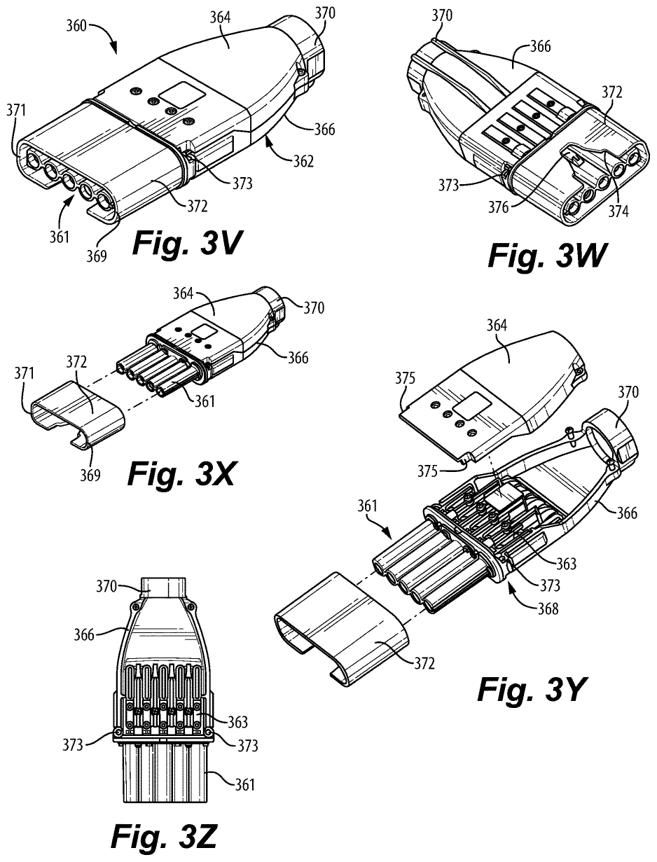

FIGS. 3A-3U illustrate various views of another embodiment of a latching assembly 340 for holding the male plug 302 in a female portion 303 of a high-current, relatively flat electrical connector 300. FIG. 3A illustrates the flat electrical connector 300 includes a male plug 302 mated to a female portion or connector 303, while FIG. 3B illustrates the male plug 302 unmated from the female portion 303. As described above, the male plug 302 includes at least one pin 301 and the female connector 303 includes at least one corresponding receptacle or sleeve 305. FIG. 3C is a bottom perspective view of the connector 300 showing the latching assembly 340. The latching assembly 340 includes a male latching member 308 and a latching receiver 306. FIGS. 3F-3L illustrate various views and cross-sectional details of the male plug 302, while FIGS. 3M-3R illustrate various views and cross-sectional details of the female connector 303.

FIGS. 3D and 3E illustrate exploded views of the latching receiver 306. The latching receiver 306 includes a pivoting latch 342 that pivots about a pivot point 352 formed on a lower surface of a housing 310 of the male plug 302. A spring 344 biases the pivoting latch 342 into a first position, as shown in FIGS. 3G and 3H. A latching cover 312 is releasably coupled to the lower surface of the housing 310 to retain the spring 344 and pivoting latch 342 to the lower surface of the housing 310. In one embodiment, the latching cover 312 is retained by two arms 353 that protrude from a surface of the housing 310 of the male plug 302. The latching cover 312 includes tabs 351 which enable the latching cover 312 to be secured to the arms 353. Each tab 351 includes an aperture 355 for receiving a fastener, e.g., a screw, to secure the latching cover 312 to the arms 353. It is to be appreciated that the latching receiver 306 and/or latching cover 312 may be replaceable by simply removing the fasteners and coupling a new latching receiver 306 and/or latching cover 312 to the arms 312.

A slot 313 is formed in a first end 311 of the housing 310 to guide the latching member 308 into contact with the pivoting latch 342. It is to be appreciated that end 311 acts as a shroud to physically protect pins 301 and to provide electrical arc containment. As shown in FIGS. 3N and 3R, the latching member 308 is centrally disposed on a surface of the female connector which corresponds to a location of the slot 313 on the male plug 302.

It is to be appreciated that end 311 is configured to prevent improper mating of the male connector 302 to the female connector 303, e.g., if one of the connectors is inverted or upside down. As shown in FIGS. 3D and 3F, end 311 is configured with a semi-circular surface 357 and a flat surface 359. Correspondingly, sleeve portion 305 of female connector 303 is configured with a rib 365 on one side and a flat surface 367 on an opposite side. Male connector 302 will only couple to female connector 303 when semi-circular surface 357 aligns with rib 365 and flat surface 359 aligns with flat surface 367. If in an inverted position, rib 365 will interfere with flat surface 359 and flat surface 367 will interfere with semi-circular surface 357 preventing the mating of the connectors 302, 303.

FIGS. 3S-3U illustrate side views of the latching assembly 340 for holding a male plug in a female receptacle of a high-current, relatively flat electrical connector (e.g., connector 300). The latching assembly 340, in some embodiments, may be designed to latch in a way for better retention. As illustrated, the latching assembly 340 includes a pivoting latch 342, which is spring loaded using spring 344, to stay in the “latched” position. A ramp 346 on the receiving end (e.g., female portion of the connector) guides the pivoting latch 342 up and over a latching surface 348. Once over the latching surface 348, the spring 344 pivots a latch component 350 of the pivoting latch 342 into the latched position.

An advantage of this design includes a mechanical advantage that allows the latching assembly 340 to disengage with minimal effort while the spring 344 provides strong latching engagement. For instance, the distance from a pivot point 352 to the latching surface 348 is greater than the distance from the pivot point 352 to the spring 344, thereby resulting in the mechanical advantage for the operator.

Referring to FIGS. 3V-3Z, another embodiment of the female connector is illustrated. The female connector 360 includes a housing 362 which includes an upper housing 364 and lower housing 366. As shown in FIG. 3Y, the lower housing 366 supports the contacts 368 of the female connector 360. It is to be appreciated that each of the contacts 368 include a receptacle or sleeve portion 361 and a corresponding conductor termination portion 363 for receiving individual conductors. Removing the upper housing or cover 364 exposes the termination portion 363 enabling individual conductors (not shown) to be passed through collar or hub 370 and subsequently terminated to contacts 368. It is to be appreciated that contacts 368 may include any of the contacts described in the present disclosure. In one embodiment, the collar or hub 370 may be threaded on its inner surface to be coupled to, for example, flexible metallic conduit, a multi-conductor cable, etc.. In another embodiment, the collar or hub 370 constructed with the lower housing 366 as an integrated component. Although the collar or hub 370 is shown as a 2 inch NPT connection, other sizes such as 1 inch, 1.¼ inches, etc. are contemplated to be within the scope of the present disclosure.

Connector 360 further includes a shroud 372 for physically protecting the receptacle or sleeve portion 361 and for arc containment. The shroud 372 is generally flat and rectangular with open ends to mate with an end of the housing 362. When disposed over sleeve portion 361, the shroud 372 creates an envelope around the sleeve portion 361 for arc containment. As shown in FIG. 3W, the shroud 372 includes a cutaway or recessed portion 374 to expose a latching member 376 (e.g., similar to the latching member 308 shown in FIG. 3C). It is to be appreciated that the recessed portion 374 is configured in a shape to receive the latching receiver 306 of the male plug 302 shown in FIG. 3C. When the male plug 302 is fully inserted into the female connector 360, the latching receiver 306 will be fully mated to the recessed potion 374. It is to be appreciated that shroud 372 may be employed in other embodiments of female connector of the present disclosure, for example, female connector 303. It is further to be appreciated that the when the male plug 302 is fully inserted into the female connector 360, the shroud 372 substantially surrounds or envelopes the interconnection of the pins and sleeves and will contain electrical arcs generated therein between the sleeves.

It is further to be appreciated that shroud 372 is configured to ensure proper mating with a corresponding connector. Shroud 372 includes a semi-circular surface 371 and flat surface 371, similar to end 311 shown in FIG. 3D. Similar in operation to end 311 described above, Surfaces 369, 371 prevent improper mating of connector 360 to an appropriate corresponding connector.

In one embodiment, lower housing 366 of connector 360 further includes apertures 373 on lateral sides of the housing 360. Upper housing 364 includes corresponding recesses such that when upper and lower housings 364, 366 are mated, various fastening devices may be employed with the apertures to secure connector 360 to a structure. For example, a bracket or screws may pass through aperture 373 to secure the connector to a cable tray.

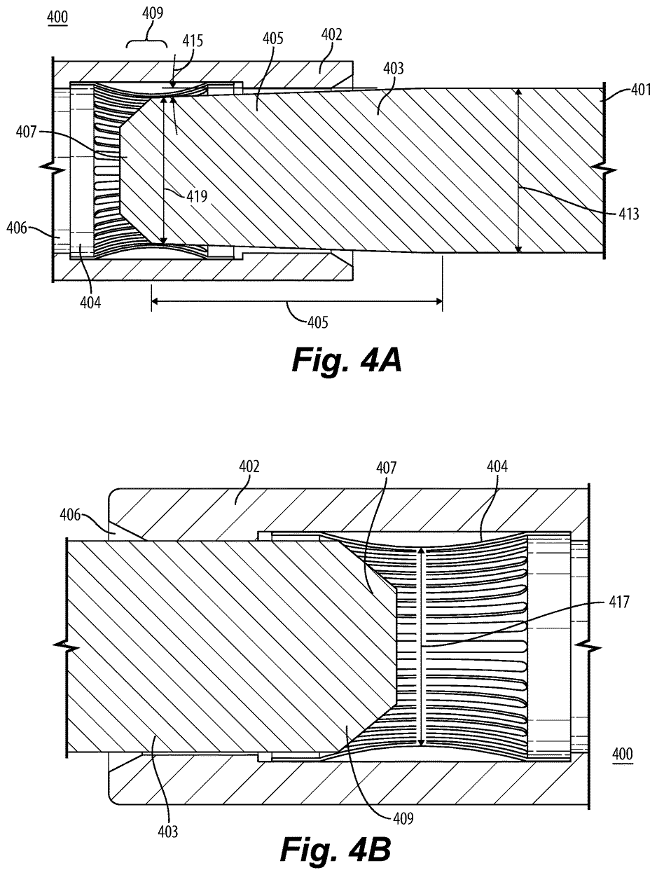

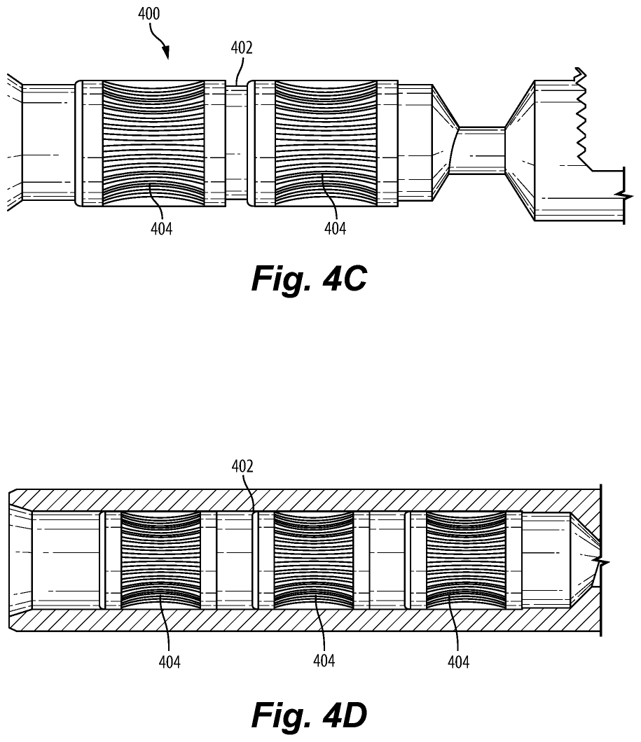

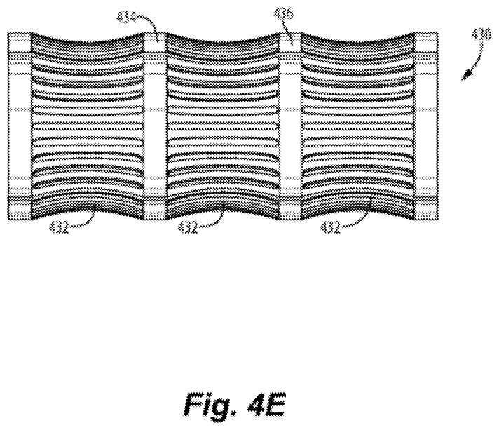

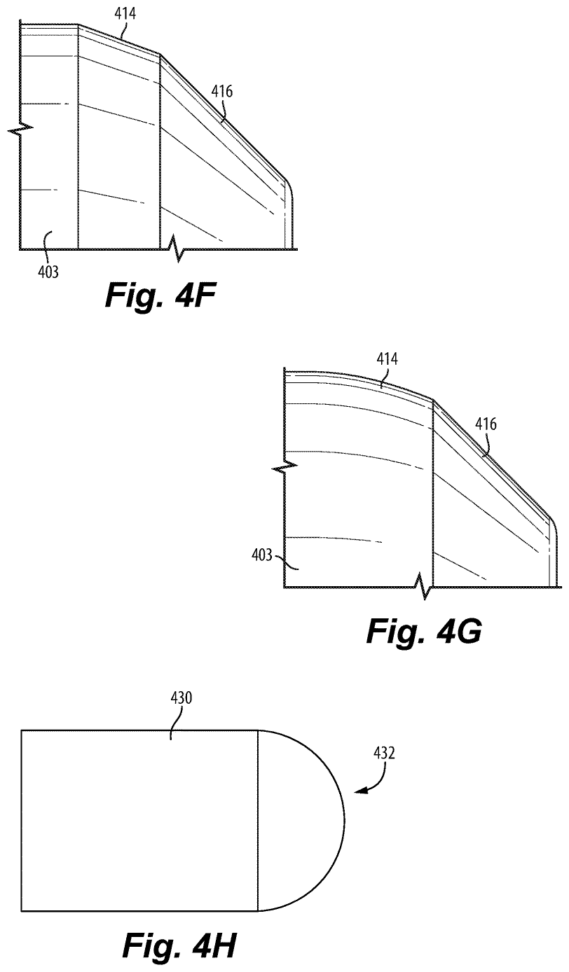

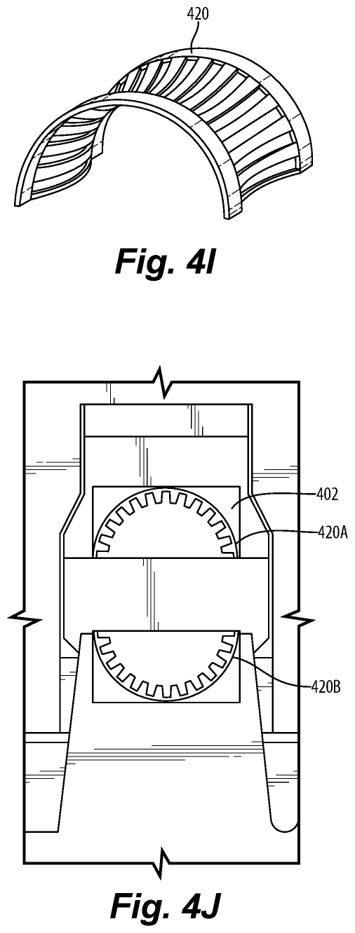

FIG. 4A is a cutaway view depicting an embodiment of a pin-and-sleeve connectivity device with a tapered diameter insertion pin. FIG. 4B is a cutaway view depicting an embodiment of a pin-and-sleeve connectivity device with a reduced spring element engagement. FIGS. 4C and 4D are cutaway views depicting an embodiment of a pin-and-sleeve connectivity device with multiple springs in the insertion sleeve. FIGS. 4E and 4F illustrate embodiments of pin tips with blended radii. FIG. 4G a perspective view of an embodiment of a half-round spring element for use in the insertion sleeve. FIG. 4H is a cutaway of an embodiment of a pin-and-sleeve connectivity device with opposing half-round spring elements in the insertion sleeve.

For example, FIGS. 4A-D depict embodiments of pin-and-sleeve type connectors for use in achieving various of the advantageous features of the present disclosure. As shown in FIG. 4A, a pin-and-sleeve connectivity device 400 is provided with an insertion pin 401 of a male portion having one or more insertion pins 403 having a gradual taper 405 (or tapered element). The connectivity device 400 also includes a sleeve 402 (or female portion) having a metallic spring element 404 located within the chamber 406 of the sleeve 402 and positioned to exert mechanical force on a respective insertion pin 403. The pin insertion force is the force required to insert the insertion pin 403 into the sleeve 402. The pin retraction force is the force required to remove the insertion pin 403 from the fully inserted position out of the sleeve 402.

As will be appreciated by one of ordinary skill in the art, the mechanical force between the spring element 404 and the insertion pin 403 serves to create a low impedance electrical connection between the pin and sleeve. Temperature rise at the mating interface correlates to the impedance and a certain minimum amount of “normal force” is needed at the contact mating interface to achieve a “good” connection. The spring element 404 also contributes to the conductivity between the sleeve 402 and insertion pin 403.

The present inventors discovered that the pin insertion force can be significantly reduced by altering certain design characteristics of pin-and-sleeve connectivity device 400 to allow for the gradual taper 405 of insertion pin 401. The insertion force is significantly lowered by adding the gradual taper 405 on distal ends 407 of insertion pins 403. In some forms, the gradual taper 405 begins at the edge of the chamfered section 409 (or rounded edge) and extends in a proximal direction a length at least equal to one-half the full pin diameter 413 of insertion pin 403.

In some embodiments, the insertion pin 403 has a chamfered section 409 to aid in lining up the insertion pin 403 with the sleeve 402 as the insertion pin 403 is first being inserted. In some forms, the chamfered section 409 runs around the edge of the distal end 407 of insertion pin 403 and is typically angled at 45°+/−15° from the flat middle portion of distal end 407. Some implementations of insertion pin 403 may have a rounded edge rather than a chamfered section 409. In some forms, the chamfered section 409 may be extended from the distal end 407 a distance of at least 10% the full pin diameter 413 of insertion pin 403.

In some forms, the gradual taper 405 (or tapered section) extends from the edge of the chamfered section 409 in the proximal direction a length of at least one-half but no greater than ten times the full pin diameter 413. In some typical implementations, the gradual taper 405 extends in the proximal direction a length of between one and ten times the full pin diameter 413 of insertion pin 403. In one implementation the gradual taper 405 extends in the proximal direction a length of 4.0+/−3.5 times the full pin diameter 413.

The gradual taper 405 preferably slopes gradually such that the pin edge diameter 419 at the edge of chamfered section 409 is less than the full pin diameter 413 further along the insertion pin 403 in the proximal direction. A typical angle of slope of the chamfered section 409—the taper angle 415-is 1.0°+/−0.5°. A taper angle 415 of 1.0° will significantly lower the insertion force by allowing the pin to encounter less friction from the spring during lateral force insertion. In other implementations the taper angle 415 may be: is 1.5°+/−0.75°; 1.5°+/−1.0°; 2.0°+/−1.5°; 2.5°+/−2.0° or any other angle of slope or range between 0.35° and 5.5°. Choosing an optimal taper is well within the ability of one of ordinary skill in the art armed with the present specification through routine experimentation taking into account the size of the connector and the spring force to be encountered.

FIG. 4B is a cutaway view depicting a pin-and-sleeve connectivity device 400 with a reduced spring element engagement, in accordance with various embodiments disclosed herein. Reducing the engagement of the spring element 404 inside the sleeve 402 (or female portion) is another design characteristic that aids in reducing the pin insertion force. This may be done by slightly increasing the inside diameter (ID) 417 of spring element 404 so it fits more loosely around the insertion pin 403, or by using a spring element 404 with less spring force so that it gives more easily as the insertion pin 403 slides into it. Reducing the engagement of the spring element 404 inside the sleeve 402 reduces the force needed to mate the insertion pins 403 into the sleeve 402. In at least one embodiment, the spring has an inside diameter 417 of 0.353 inches (as illustrated in FIG. 4B). Increasing the spring inside diameter 417 to greater than 0.353 inches—e.g., to 0.383 inches—achieves the desired reduction in pin insertion force.

FIG. 4C is a cutaway view depicting a pin-and-sleeve connectivity device 400 with multiple spring elements 404 in the sleeve 402 (insertion sleeve or female portion), in accordance with various embodiments disclosed herein. The multiple spring elements 404 are used to overcome reduced engagement of using one spring element, the reduced engagement may increase the contact resistance through the pin-spring mating interface, causing a temperature increase of the pin-and-sleeve connectivity device 400 when under a current load. Although FIG. 4C illustrates connectivity devices 400 with two spring elements 404 and three spring elements 404, it is to be appreciated the number of springs may be varied to achieve a desired effect, e.g., three springs as shown in FIG. 4D.

Variations in the installed condition of multiple springs may be minimized by configuring multiple springs as a single spring 430, as shown in FIG. 4E. With the spring convolutions 432 connected by the center spring bands 434, 436, the entire spring 430 can deflect in unison and makes pin insertion forces more uniform. It is to be appreciated that a single spring will also have more consistent performance and uniformity of radial force.

In one embodiment, the spring 430 is stamped from an appropriate flat or sheet material and configured in an open C-shape. When the spring 430 is disposed in a sleeve, the C-shaped spring 430 is compressed into a near circle (e.g., an overall cylindrical shape) resulting in the configuration shown in FIG. 4E.

Each spring element 404 creates a fixed number of “asperity spots”, also referred to as A-spots, for current to pass through. Multiple spring elements 404 create more A-spots. The more A-spots there are, the lower contact resistance and temperature rise. The use of additional spring elements 404 can help reduce the increased temperatures within the sleeve 402 by increasing the number of contact spots for the current to pass through, thus increasing the electrical conductivity which results in lowering of the temperature.

With a single spring, when inserting a pin into a sleeve, there is an initial peak insertion force when the leading edge of the pin first engages with and deforms the spring element 404. After the spring is opened up to the pin's full diameter, then the subsequent insertion force is just the sliding friction which is less than the peak insertion force. When a pin is removed from the sleeve, only the lower sliding force is experienced.

With multiple springs, the peak insertion force does not increase proportionally with the number of springs. For example, when two springs are present, the peak insertion force is not two times greater than that of a single spring. In both cases, the tip of the pin will only encounter one spring at a time. Having multiple springs does increase the sliding friction between the pin and the spring. But this can be tuned by increasing the inside diameter of the spring element 404. The spring ID can be increased quite significantly to have a “light touch” with the pin which results in lower sliding friction. This decreased normal force between spring and pin may increase the contact resistance of each touch point. But having multiple springs will offset this by creating many more touch points.

In operation, the effort is to maximize the number of touch points between the spring and the sleeve while minimizing the normal force at each touch point. Thus, one of ordinary skill in the art can optimize for pin insertion and withdrawal force and for low temperature rise, by controlling the number of springs and the spring ID using only routine experimentation.

In operation, the pin taper angle is another variable that may be optimized according to the present disclosure. In sum, any desired optimization to minimize the peak insertion force, to minimize the sliding force, and/or to minimize the temperature rise by controlling the pin tip shape and taper, the spring ID, the number of springs, and/or optionally adding highly conductive plating are all well within the ability of one of ordinary skill in the art armed with the present disclosure using only routine experimentation.

Pin and sleeve contacts with high current rating typically have high insertion forces. This makes it difficult for operators to mate a plug with a connector or receptacle. In accordance with an embodiment of the present disclosure, the pin tip taper may be optimized to minimize insertion force. For example, referring to FIGS. 4F and 4G, a pin tip with a blended radii is illustrated. The tip of insertion pin 403 includes a first chamfered portion 414 and a second chamfered portion 416. In FIGS. 4F and 4G, the first chamfered portion 414 is at a first predetermined angle relative to a longitudinal or central axis of the pin 403 and the second chamfered portion 416 is at a second predetermined angle relative to a longitudinal or central axis of the pin 403 The combination of the first and second chamfered portions 414, 416 creates a decreasing radius of the tip as the tip extends to the distal end, i.e., the second predetermined angle is greater than the first predetermined angle resulting in a decreasing radius. The blended radii make the angle transition less severe which reduces insertion force.

In another embodiment, FIG. 4H illustrates an insertion pin 430 with a fully rounded tip 432. In this embodiment, the rounded tip 432 minimizes corners which are unfavorable for arcing performance.

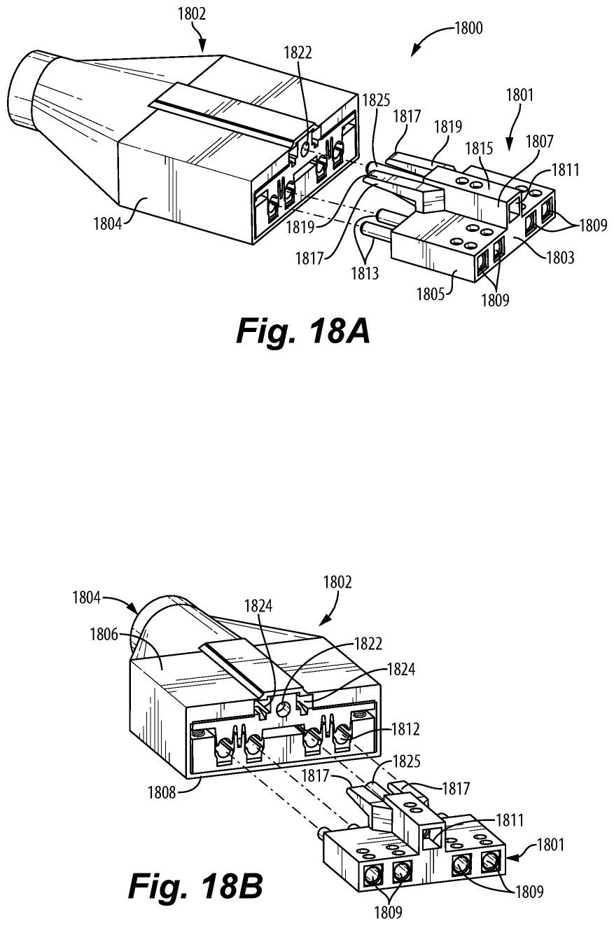

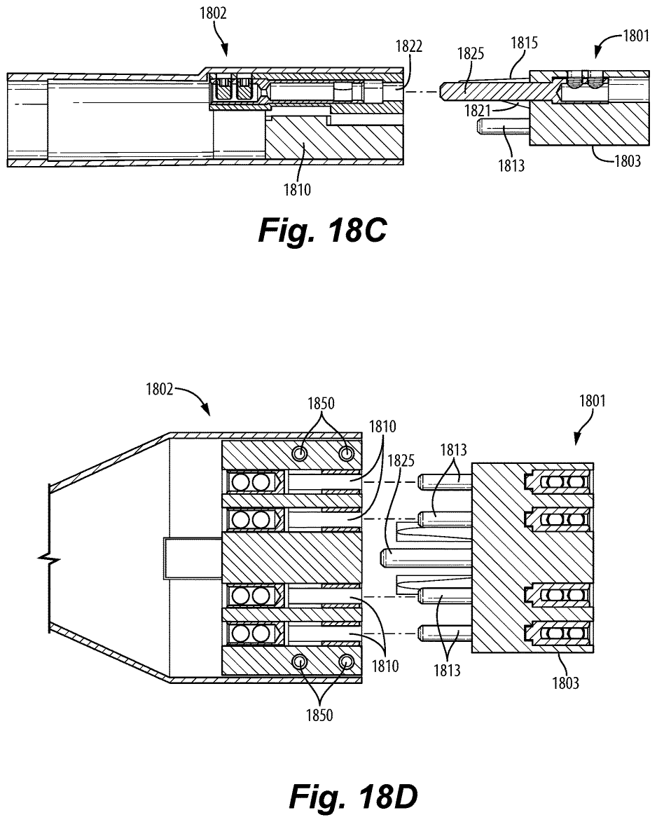

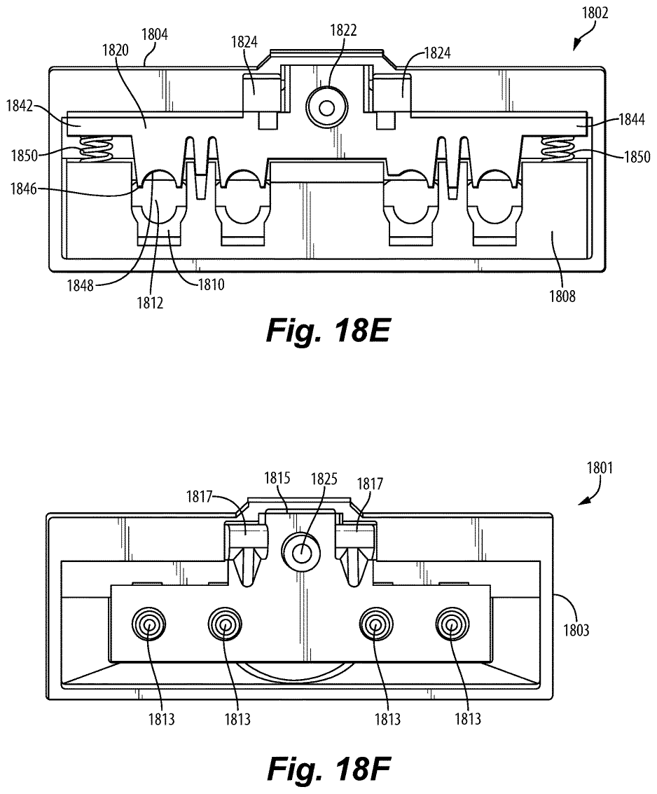

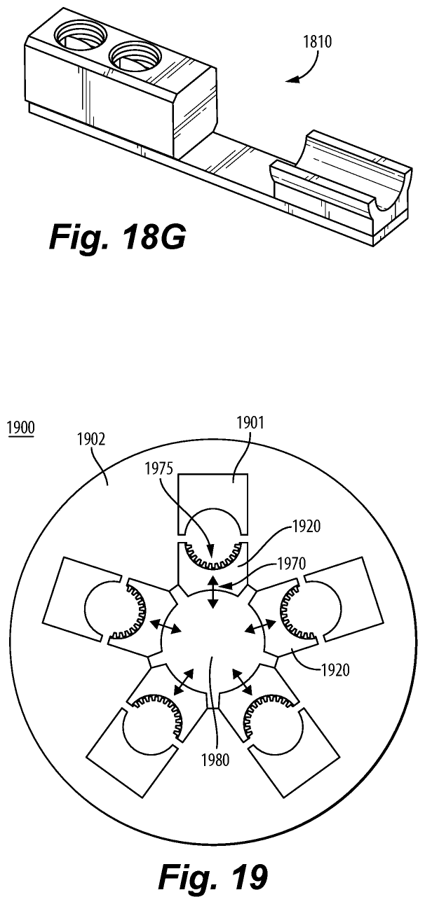

In addition to multiple springs, in some forms, a sleeve may be configured to make sure one or more or pairs of half-round spring members 420 as shown in FIG. 41. In an embodiment depicted in FIG. 4J, one or more pairs of cooperating half-round spring members 420A, 420B are disposed in the sleeve 402 and squeezed between the half-round spring elements 420. With this configuration, dimensional variations among pins are easily accommodated in a given connector. As will be appreciated, the multiple individual spring elements ensure constant contact pressure on the pin. Exemplary embodiment of connectors employing half-round spring members will be described below in relation to FIGS. 18A-18F.

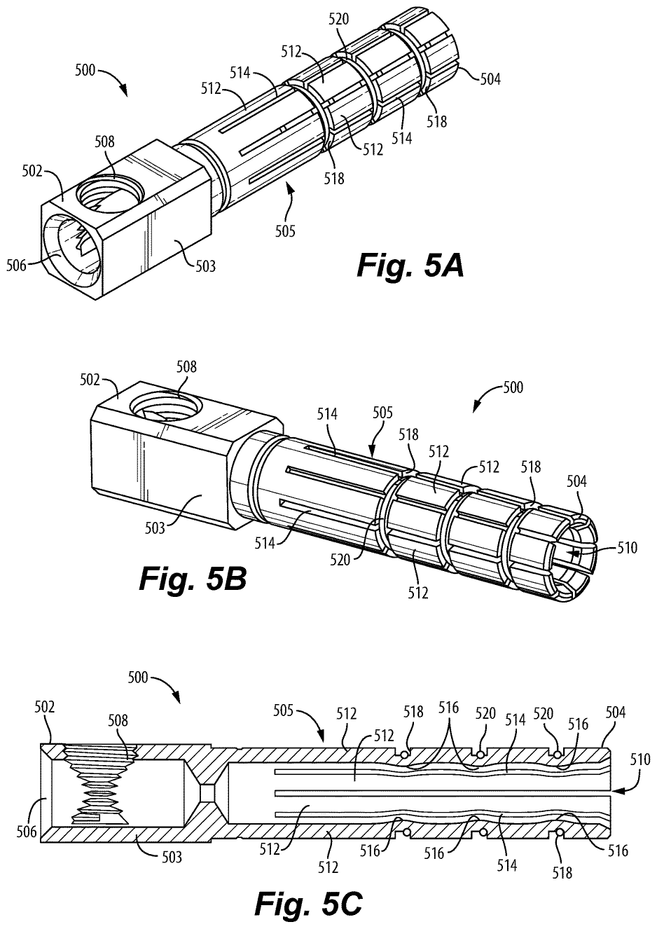

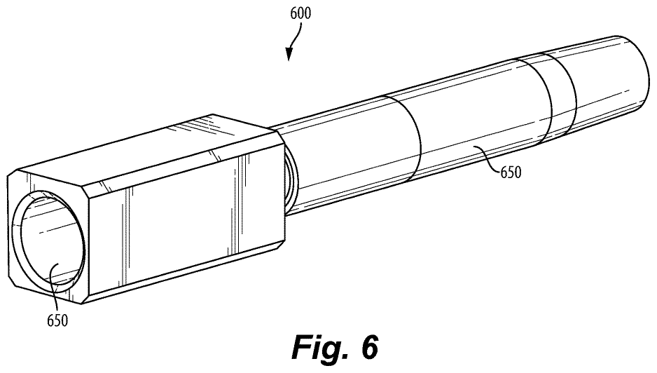

FIG. 5A is a perspective view of an embodiment of a split sleeve contact. FIG. 5B is another perspective view of an embodiment of the spilt sleeve contact as shown in FIG. 5A. FIG. 5C is a cross-sectional view of an embodiment of the split sleeve contact as shown in FIG. 5A.

In addition to multiple springs, in some forms, a split sleeve contact may be configured to increase a number of A-spots between the sleeve and pin. Referring to FIGS. 5A and 5B, perspective views of a split sleeve contact 500 are illustrated, where FIG. 5C is a cross-sectional view of the split sleeve contact 500. The split sleeve contact 500 has a first end 502 and a second end 504 and includes a termination portion 503 and sleeve portion 505. The termination portion 503 includes a first aperture 506 for receiving an end of a conductor and a second aperture 508 for receiving a set screw for securing the end of the conductor in the first aperture 506. A channel 510 runs along the longitudinal axis of the split sleeve contact 500 from the first end 502 to the second end 504. The sleeve portion 505 includes a plurality of contact members 512 separated by a plurality of slits 514. The contact members 512 are concentrically arranged around the channel 510 to receive a pin (not shown). Each contact member 512 is individually couped to the termination portion 503 such that each contact member 512 may individually flex upon receiving the pin.

Referring to FIG. 5C, each contact member 512 is configured to include a plurality of contact points 516. Each contact member 512 includes a slot 518 disposed on an outer surface of the contact member 512. Respective slots 518 on each contact member 512 align to receive a generally circular ring spring 520. When a pin is inserted into the channel 510 via the second end 504, the ring springs 520 will apply a force on the contact members 512 to urge the contact points 516 toward the center of the channel 510 and maintain contact with the pin. Each contact point 516 will create an A-spot, the more contact points 516 the better electrical performance, e.g., reduce contact resistance and temperature rise.

FIG. 6 is an oblique view depicting an embodiment of a pin-and-sleeve connectivity device 600 with silver plating 650 on key surface areas, in accordance with various embodiments disclosed herein. The conductivity of the pin and sleeve contacts can be increased by plating the surfaces with a high conductivity material such as silver. The use of selective plating, utilizing silver on all interfacing surfaces, is added to the electrical contacts as shown in FIG. 6. These areas include the surface where the spring element 404 touches the sleeve 402, and the surface of the insertion pin 403 that touches the spring element 404. The thickness of silver is optimized to maximize electrical efficiency, thereby minimizing resistance that generates unwanted heat that has to be managed and removed, increasing operating cost.

In some implementations the silver plating 650 is only applied to critical areas where contact is made in order to save on material costs. In other implementations, entire parts are plated to streamline the manufacturing process.

In further implementations, the pin and/or sleeve contact may be made of highly conductive contact materials. Contacts heat up while carrying a high current. Existing pin and sleeve connectors use brass for the contacts. Typically, brass has an electrical conductivity ranging from 23% to 44% IACS, depending on the specific type of brass. For reference, the conductivity of copper is 100% IACS. In one embodiment, the pin and sleeve contacts are constructed from Tellurium Copper (C14500: 99.2 to 99.596% copper, 0.4 to 0.7% tellurium, and 0.004 to 0.012% phosphorus) with electrical conductivity of about 90% IACS. Other material may include but are not limited to Copper Chromium (C18200: nominal composition of 99.1% copper and 0.9% chromium, the chromium content typically falls within a range of 0.6% to 1.2%. ; −80% IACS) and Copper Zirconium (C15000: 99.8% min copper and 0.1-0.2% zirconium; −80% IACS). By employing such materials for pin and sleeve connectors lower temperature rise and improved resistance to arcing can be achieved. It is to be appreciated that the pin and sleeve contacts may be made from bar stock of a copper alloy by several machining methods, including CNC machining, milling machining, turning machining, grinding and drilling. In another embodiment, the pin and sleeve contacts may be configured from a copper alloy specifically design to enhance electrical and thermal conductivity by a copper casting process, for example, sand casting shell mold casting, investment casting, centrifugal casting, continuous casting, etc. In a further embodiment, the pin and sleeve contacts may be configured from a copper alloy using a metal injection molding process or 3D printing process.

In operation, when a user desires to make an electrical connection using a pin-and-sleeve configuration of the types described above, the male end and female ends are brought into proximity. The pins of the male end are aligned with the respective pin receptacle openings of the female end. The alignment may be facilitated by the chamfered section as described above. The pins are then frictionally fit into the receptacles and lateral force is exerted to flex the springs radially to allow the pins to move laterally until the full length of the pins are received in the female receptacles and secured from the outside environment. The insertion force of the connection is eased by the tapering of the distal ends of the pins reducing the force necessary for insertion. The force may also or alternatively be reduced by providing one or more springs providing less radial spring force against the pins.

In various embodiments and uses, the female receptacles may make use of multiple springs to provide additional retention force, additional contact points for heat mitigation, or for other advantageous reasons. Likewise, the connector may use a sliver coating in areas of contact or throughout to provide additional conductivity benefits.

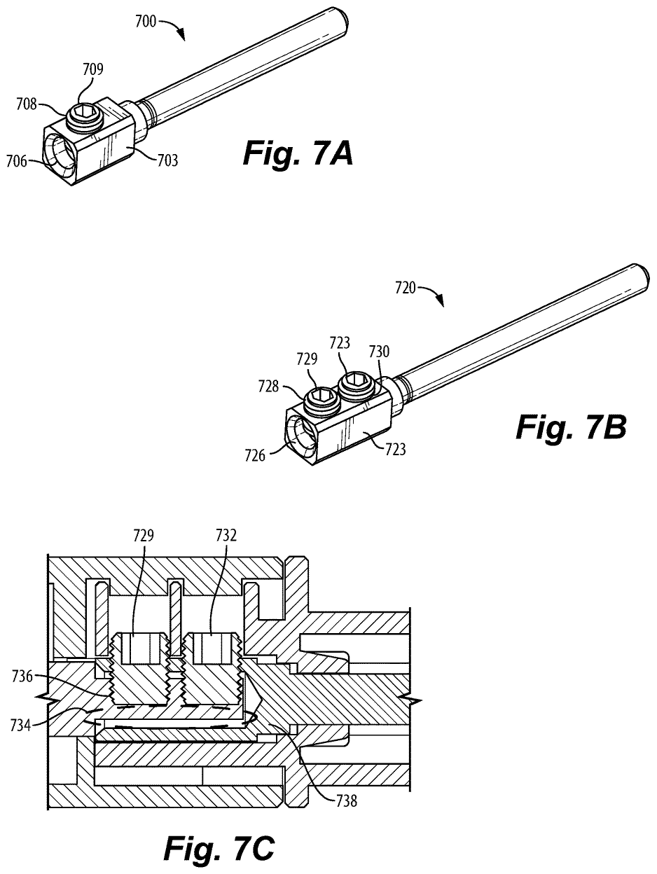

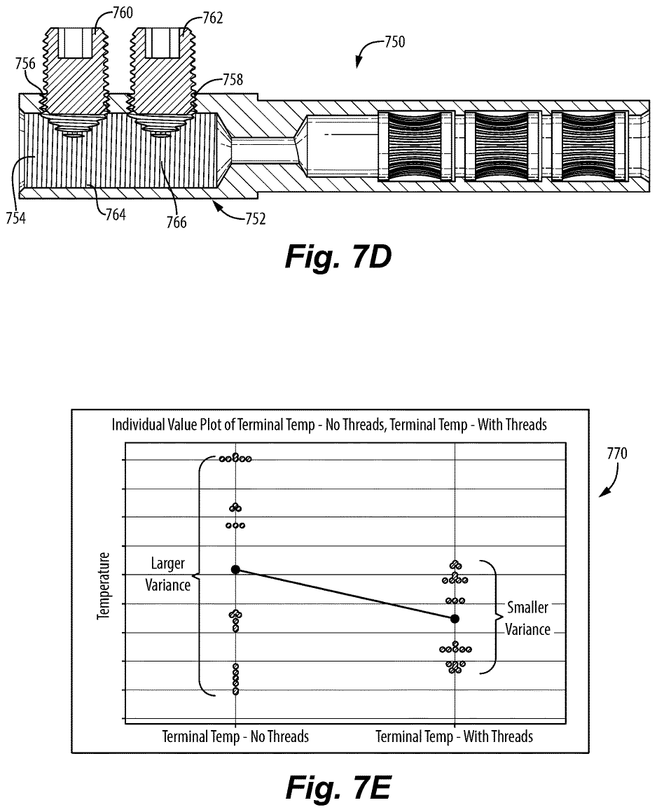

FIG. 7A is a perspective view of a conventional contact. FIG. 7B is a perspective view of an embodiment of a multi-termination contact. FIG. 7C is a cross-sectional view of an embodiment of the contact shown in FIG. 7B.

Terminal screws are typically used to connect a wire or conductor to a pin or sleeve connector. FIG. 7A illustrates a conventional contact 700. The contact 700 may be a sleeve contact or a pin contact. The contact 700 includes a termination portion 702 having a first aperture 706 for receiving a wire or conductor and a second aperture 708 for receiving a screw 709 for compressing and securing the wire or conductor in the first aperture 706. The possibility of stress relaxation of the compressed wire under a screw is a known phenomenon, which effects reliable power distribution that may be mission-critical in data centers.

By providing multiple termination screws, the possibility of stress relaxation can be reduced while increasing the high-pressure connection area between the wire and terminal to reduce contact resistance and temperature rise. Referring to FIGS. 7B and 7C, a contact 720 is illustrated in accordance with an embodiment of the present disclosure. The contact 720 includes a termination portion 702 having a first aperture 726 for receiving a wire or conductor. The contact 720 further includes second and third apertures 728, 730 for receiving screws 729, 732, respectively. By employing multiple screws 729, 732, the high pressure connection area 734 between the wire 736 and terminal 738 is increased as compared to conventional contact.

Further to the goal of reducing unwanted heat rise, the present disclosure provides alternative ways to terminate conductors. Conventionally, terminal screws are employed to engage terminal conductors. Conductivity relies on the screws pressing the conductor against the opposite wall in the terminal bore. Approximately half of the conductor surface area makes contact with the highly conductive sleeve material. Terminal screws are typically made from stainless steel and less conductive. In addition, the terminal bores are typically smooth. Adding points of asperity inside the terminal bore or cavity using threads or ribs creates predictable points of contact to the conductor to decrease contact resistance between the wire and the terminal. This will decrease joule heating.

Referring to FIG. 7D, a contact 750 is illustrates in accordance with an embodiment of the present disclosure. The contact 750 includes a termination portion 752 having a first aperture 754 for receiving a wire or conductor. The contact 750 further includes second and third apertures 756, 758 for receiving screws 760, 762 respectively. As described above, a bore or cavity 764 of the termination portion 752 receives a conductor (not shown). The conductor is pressed into engagement of a surface of the bore or cavity 764. In this embodiment, the surface of the bore or cavity 764 is configured with threads 766 to create predictable points of contact to the conductor to decrease contact resistance between the conductor and the termination portion 752 of the contact 750. The decrease in contact resistance will decrease joule heating, as shown in FIG. 7E. FIG. 7E is an exemplary graph 770 comparing the temperature of a contact with no threads in the bore of the termination portion versus a contact with threads in the bore of termination portion. As can be seen in FIG. 7E, experimental results indicate that contacts having threads in the bore of the termination portion of the contact generate a lower temperature, i.e., due to decreased joule heating, then contacts with no threads.

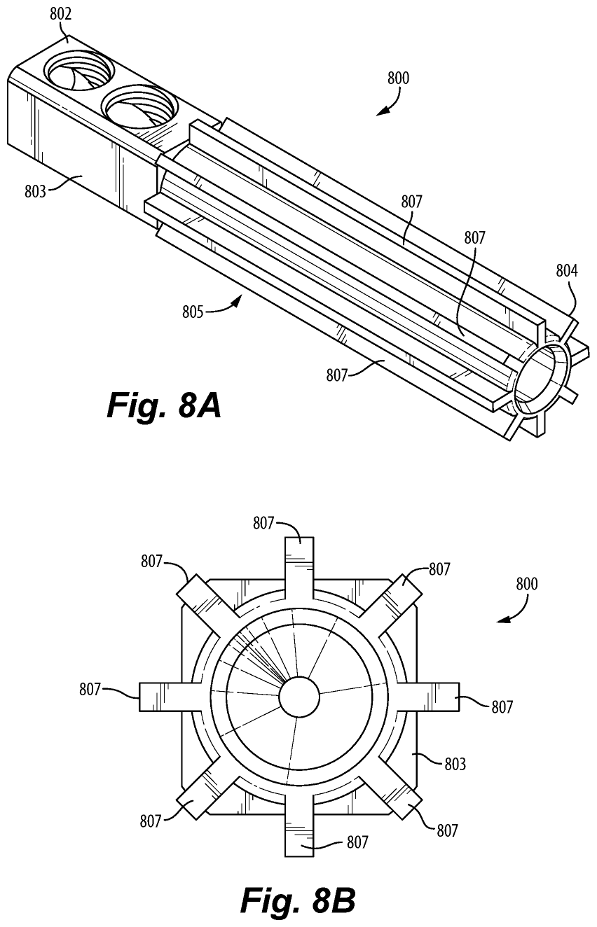

FIG. 8A is a perspective view of an embodiment of a sleeve contact with heat sink. FIG. 8B is a front view of an embodiment of the sleeve contact with heat sink as shown in FIG. 8A.

Further to the goal of reducing unwanted heat rise, the present disclosure provides alternative ways to terminate conductors. Conventionally, terminal screws are employed to engage terminal conductors. Conductivity relies on the screws pressing the conductor against the opposite wall in the terminal bore. Approximately half of the conductor's surface area makes contact with the highly conductive sleeve material. Terminal screws are typically made from stainless steel and less conductive, with a typical conductivity of 2-3% IACS. To further reduce contact resistance at the wire or conductor terminal, the terminal screws may be made from significantly more conductive materials that are sufficiently strong. For example, beryllium copper with 15-30% IACS may be used in terminal screws (Beryllium copper C17200: copper 98%, beryllium 1.8% to 2.0%, Cobalt+Nickel 0.2% combined minimum, Ni+Co+Fe 0.6 max, Al 0.20 max, Si 0.20 max). By doing so, the electrical path from the wire or conductor through the screw to the contact terminal is enhanced. In addition to beryllium copper, other high strength copper alloys exist, such as Copper-Titanium (CuTi) (e.g., C1990 Titanium Copper: 2.90-3.50% titanium and the remainder copper). In addition, the terminal bores are typically smooth. Adding points of asperity inside the terminal bore using threads or ribs creates predictable points of contact to the conductor to improve heat transfer.

By doing so, the electrical path from the wire or conductor through the screw to the contact terminal is enhanced. In addition to beryllium copper, other high strength copper alloys exist, such as Copper-Titanium (CuTi). In addition, the terminal bores are typically smooth. Adding points of asperity inside the terminal bore using threads or ribs creates predictable points of contact to the conductor to improve heat transfer.

It is to be appreciated that the screws may be made from bar stock of a copper alloy by several machining methods, including CNC machining, milling machining, turning machining, grinding and drilling. In another embodiment, the screws may be configured from a copper alloy specifically design to enhance electrical and thermal conductivity by a copper casting process, for example, sand casting shell mold casting, investment casting, centrifugal casting, continuous casting, etc. In a further embodiment, the screws may be configured from a copper alloy using a metal injection molding process or 3D printing process.

Further to the goal of reducing unwanted heat rise, the present disclosure provides alternative ways to dissipate heat from conductors and/or contacts.

Joule heating of contacts contributes to temperature rise while a device carries current. In one embodiment, a heat sink may be applied to a contact to buffer against heat spikes from transient high current draw. Referring to FIGS. 8A-8B, a sleeve contact 700 is provided for reducing a peak temperature rise from transient high current draw. Sleeve contact 800 has a first end 802 and a second end 804 and includes a termination portion 803 and sleeve portion 805. The sleeve portion 805 includes a plurality of heat sink fins 807 that extend radially from a longitudinal axis of the sleeve contact 800. It is to be appreciated that the heat sink fins 807 may be attached as a separate component (e.g., a sleeve component) or may be integral to the sleeve portion 805. The heat sink fins 807 will draw heat generated inside the sleeve portion 805, e.g., at contact points between a spring and conductor, away from the conductor.

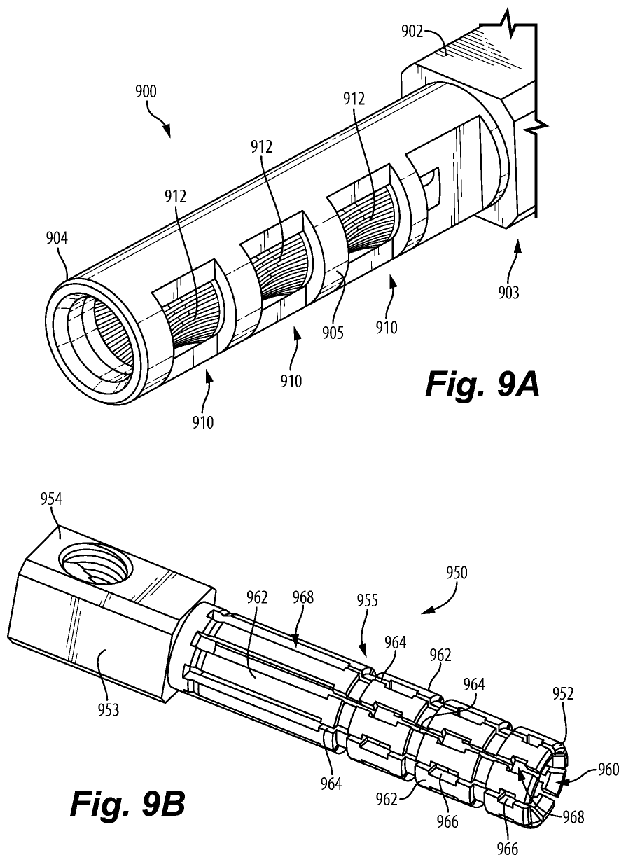

FIG. 9A is a perspective view of an embodiment of a sleeve contact with venting elements. FIG. 9B is a perspective view of another embodiment of the sleeve contact with venting elements.

In a further embodiment, a connector 900 is provided with venting slots 910 as shown in FIG. 9A. Sleeve contact of the connector 900 has a first end 902 and a second end 904 and includes a termination portion 903 and sleeve portion 905. The sleeve portion 905 includes a plurality of venting slots 910 which enable heat dissipation at contact points between a spring and conductor. In one embodiment, each venting slot 910 is aligned with an internally disposed spring contact 912 such that contact points that are created at the concave portions of the spring contact are exposed through the venting slots 910. Although the venting slots 910 are shown in FIG. 9A on one side of the sleeve portion 905, it is to be appreciated that the venting slots 910 may be disposed on both side of the sleeve portion 905 or in any other position on the sleeve portion 905.

In another embodiment, a modified version of split sleeve contact 500 described above in relation to FIGS. 5A-5B is provided to have improved heat dissipation. Referring to FIG. 9B, a split sleeve contact 950 has a first end 952 and a second end 954 and includes a termination portion 953 and sleeve portion 955. A channel 960 runs along the longitudinal axis of the split sleeve contact 950 from the first end 952 to the second end 954. The sleeve portion 955 includes a plurality of contact members 962 separated by a plurality of slits 964. The contact members 962 are concentrically arranged around the channel 960 to receive a pin (not shown). Each contact member 962 is individually couped to the termination portion 953 such that each contact member 962 may individually flex upon receiving the pin. In this embodiment, portions of each contact member 962 includes at least one recess 966 along a respective slit 964 forming venting slots 968 with adjacent contact members 962.

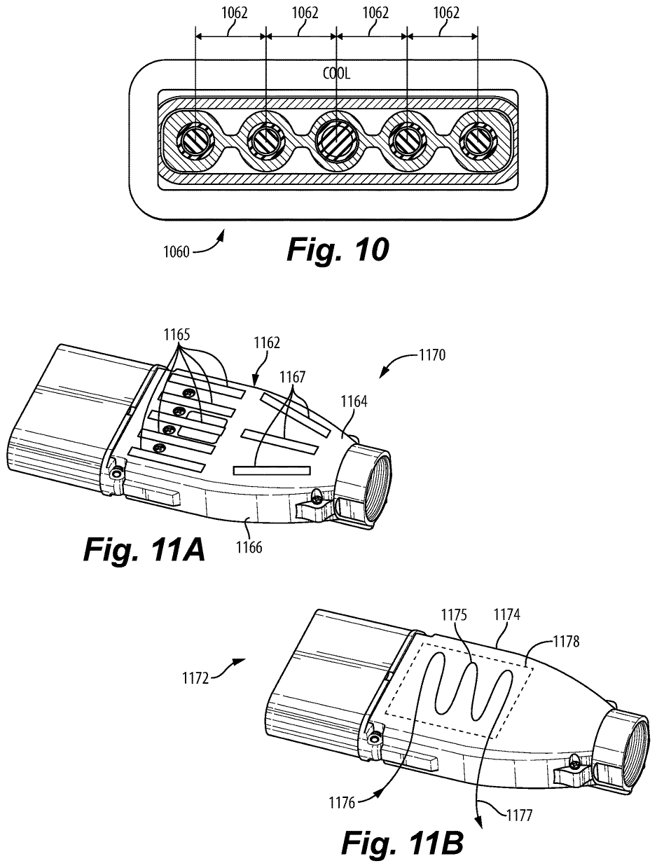

FIG. 10 is a front view of an embodiment of a male plug 1060 of a high-current, relatively flat electrical connector having a contact arrangement to dissipate heat. In some embodiments, the male plug 1060 may be the same as or have similar features to the male plug 12 of FIG. 1A. In particular, the male plug 1060 is illustrated to demonstrate the array of contacts and how they are arranged. With the specific linear array of contacts as shown, a spacing 1062 of contacts is configured to exceed 100 A IEC specifications. The advantage is that additional contact-to-contact spacing 1062 is configured to increase arc resistance (i.e., reduce arcing). Also, the linear array provides greater perimeter surface area than a circular array. The additional perimeter surface area is therefore configured to improve cooling (or heat dissipation) of conductors.

It is to be appreciated that the various above-described embodiments for the pin and sleeve contacts may be employed in the linear design of the connector and cables resulting in multiple design elements that are configured to reduce contact resistance. Also, the multiple design elements of the present disclosure are further configured to dissipate heat more efficiently.

According to some embodiments, the plug and connector embodiments may include various types of “venting” mechanisms for further ventilation and heat dissipation. It may be noted that male (plug) and/or female (receptacle) housings may inherently trap heat if no ventilation is incorporated in the design. This contributes to temperature rise while devices carry current. In one embodiment of the present disclosure as shown in FIG. 11A, thermally conductive plastic may be used to help the housings 1162 dissipate heat. In a further embodiment, venting elements 1165, 1167 in the housing 1162 may be provided. The venting elements 1165, e.g., slots, may be positioned on an outer surface of the housing 1162 to align the contact sleeves/pins to be parallel to the venting elements 1165. The vents dissipate heat from within the wiring device. The dissipated heat can then be carried away (e.g., from a data center's cooling infrastructure). Although the venting elements shown in FIG. 11A are disposed on an upper housing 1164 of housing 1162 of female connector 1170, the venting elements 1165, 1167 may be disposed in other locations, for example, on a surface of a lower housing 1166. It is to be appreciated that the venting elements 1165, 1167 may be disposed on a housing of a male connector or plug or can be disposed on both a male and female connector configured to be mated together.

In other embodiments, the housings of the wiring device may be cooled by liquid circulation as described herein. In one embodiment, a contact housings may include a liquid circulation system that circulates a dielectric (e.g., non-conductive) coolant through a wiring device's interior, as shown in FIG. 11B. In this embodiment, the housing 1174 of female connector 1172 may include a plurality of ducts or conduits 1175. An input port 1176 may be configured to feed the coolant to the ducts or conduits 1175, and an output port 1177 allows the coolant to exit the housing 1174. The liquid cooling enables a wiring device to handle multiple times the current versus configurations without these features. In another embodiment, a sealed liquid circulation module 1178 (e.g., “cold plate”) may be disposed within or on a wiring device. In one embodiment, a circulation module may be configured as a flat plate to be placed over the flat housing.

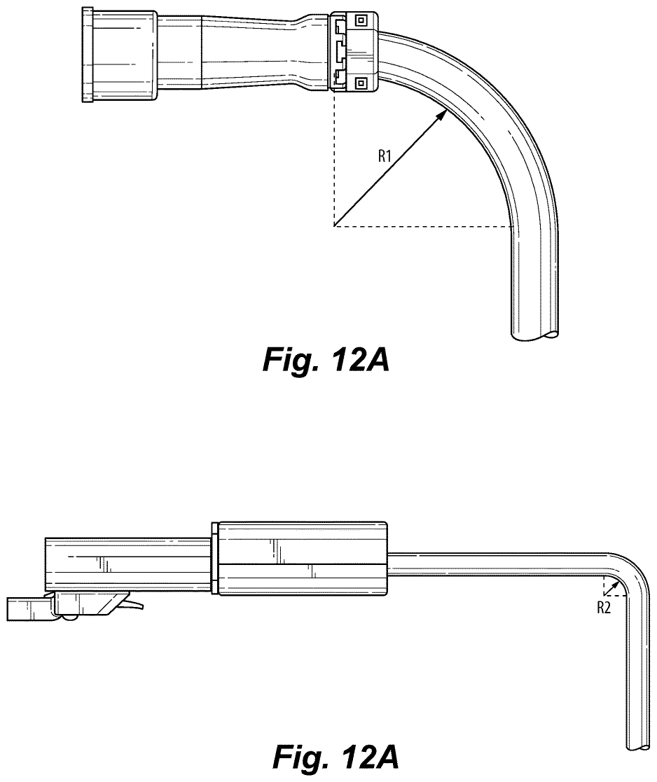

FIGS. 12A and 12B are side views showing a conventional electrical connector bundle having a round form factor (FIG. 12A) and the electrical connector, in accordance with embodiments of the present disclosure, having a relatively flat form factor (FIG. 12B). In particular, FIGS. 12A and 12B show the differences in bend radius of the conventional cable with the present embodiments. The conventional cable (with round design) has a bend radius of R1, which may be significantly larger than the bend radius R2 of the implementations discussed herein having a flat design. As a result, the present embodiments simplify the running of connectors and cables throughout a data center or other high-power facilities, by allowing individual conductors to bend around corners of racks more easily, network equipment, walls, etc.

Cords at high current ratings (e.g., ≥100 A) are big and hard to flex. If such cords are terminated to a wiring device, then the device becomes too difficult to handle for a typical network operator or technician. The flat device is designed to work with individual conductors, which are easy to bend and are designed to bend at the same angles without stretching or compressing certain conductors within the bundle. Conductors dwell within a flexible conduit, which can be easy to bend. In comparison, a high current jacketed multi-conductor cord of the conventional arrangements is hard to bend. Along with the use of flexible conduits, the terminated wiring device is easier to maneuver than if terminated with a larger jacketed (round) cord.

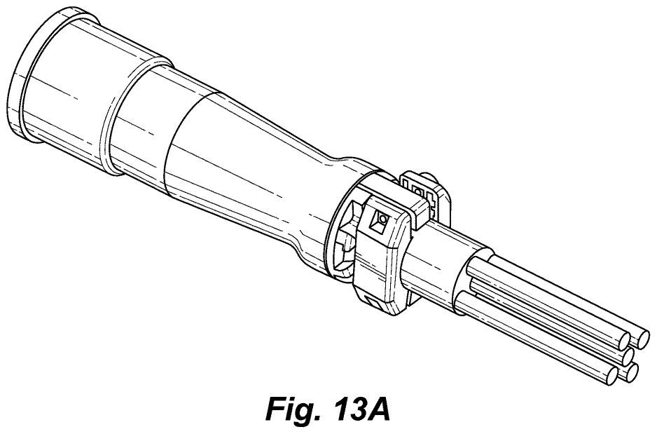

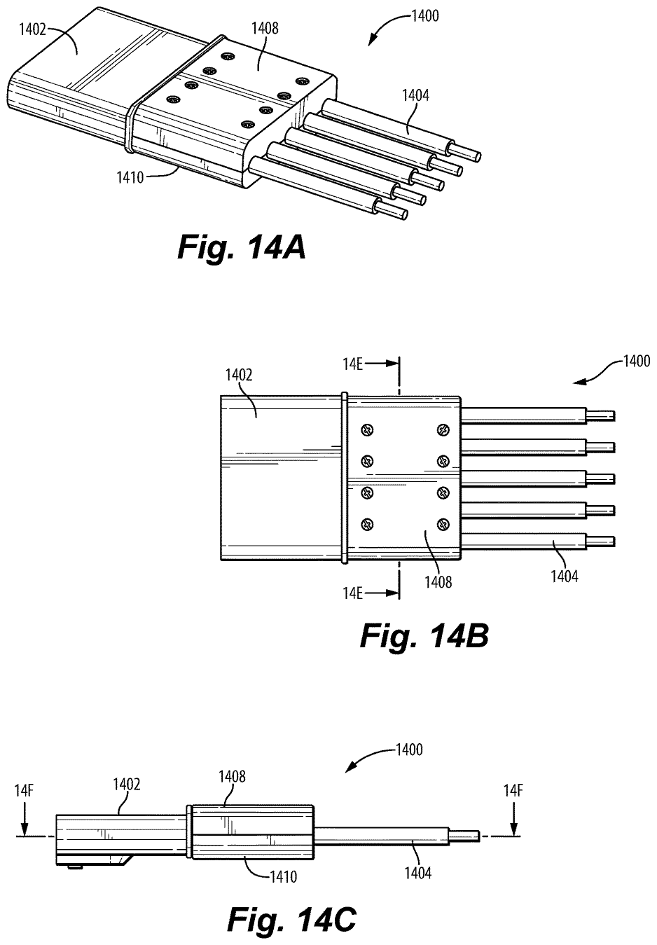

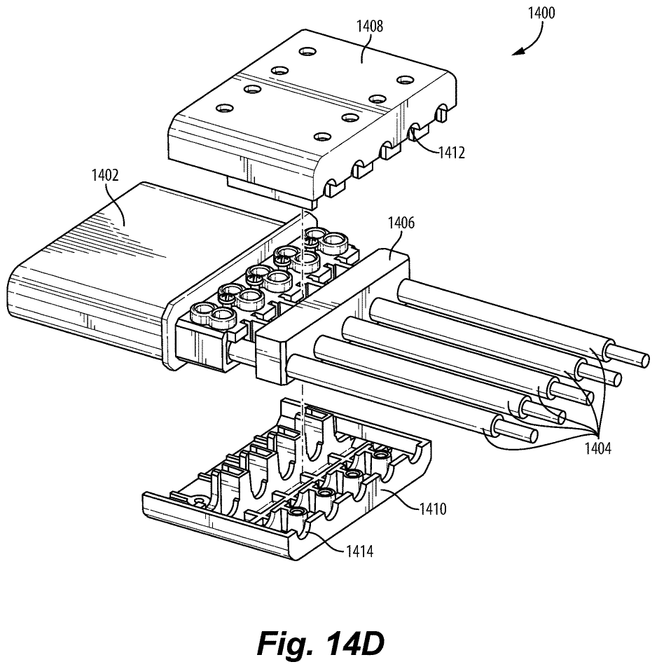

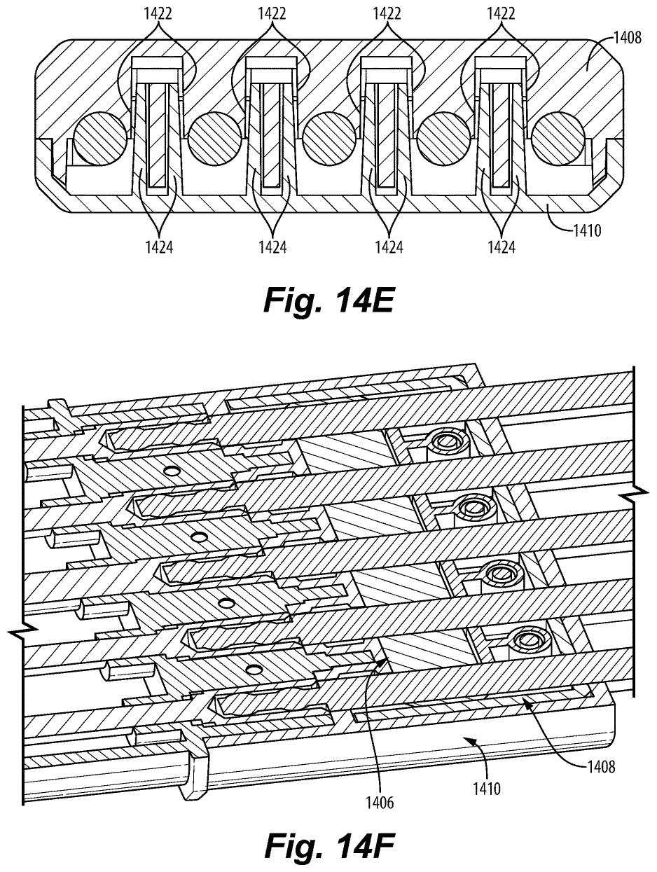

Strain relief of conventional multi-conductor cables (as shown in FIG. 13A) becomes cumbersome for higher amperage applications, due to the large cable diameters, large bend radii, and stiffness of these cables. In the present disclosure, embodiments are provided where devices contain individual conductors having a flat rectangular footprint. FIG. 14A is perspective view depicting an embodiment of strain relief assemblies of a high-current, relatively flat electrical connector. An advantage of this design element is that individual conductors with the rectangular footprint are more easily routed into typical openings of Power Distribution Units (PDUs) in cabinets. Also, the conductors may be configured to fit more easily within or lay in power troughs with more space efficiency.

FIGS. 14A-14D illustrate the strain relief assembly 1400 for a high-current, relatively flat electrical connector. Again, strain relief of conventional multi-conductor cables becomes cumbersome for higher amperage applications, due to the large cable diameters, large bend radii, and stiffness of these cables. In the present disclosure, embodiments are provided where devices contain individual conductors having a flat rectangular footprint. An advantage of this design element is that individual conductors with a rectangular footprint are more easily routed into typical openings of PDUs in cabinets. Also, the conductors may be configured to fit more easily within or lay in power troughs with more space efficiency.

Referring to FIGS. 14A-14E, the assembly 1400 includes a pin contact holder 1402 configured to arrange a plurality of pin contacts in a linear manner and for coupling the pin contacts to a respective conductor 1404. A grommet 1406 is disposed over the plurality of conductors 1404 and is sandwiched between upper housing 1408 and lower housing 1410. Each of the upper and lower housings 1408, 1410 include semi-circular features 1412, 1414 respectively that compress the conductors 1404 when the upper and lower housings 1408, 1410 are brought together and tightened. Additionally, the grommet 1406 grabs the conductors 1404 when the grommet 1406 is compressed by the upper and lower housings 1408, 1410. It is to be appreciated that the combination of the grommet 1406 and upper and lower housings 1408, 1410 grabbing the conductors 1404 provide improved strain relief.

The assembly 1400 provides for improved water ingress prevention. Referring to FIGS. 14E and 14F, the illustrated implementation includes overlapping walls 1422, 1424 on the housings 1408, 1410 respectively and a multi-cable grommet 1406. The grommet 1406 will provide a seal to minimize water ingress from the cable end of the devices. An advantage of this design is that it is able to minimize potential ingress of water by creating a labyrinth for the leak path. Also, the compressed grommet seal forms a seal around cables and between upper and lower strain relief housings 1408, 1410. The flat design has features to minimize water ingress. Overlapping walls help to accomplish this. The grommet 1406 will help to keep any water propagation from the cable end up to the terminals. Also, an upper strain relief housing 1408 nests inside lower strain relief housing 1410 on three sides.

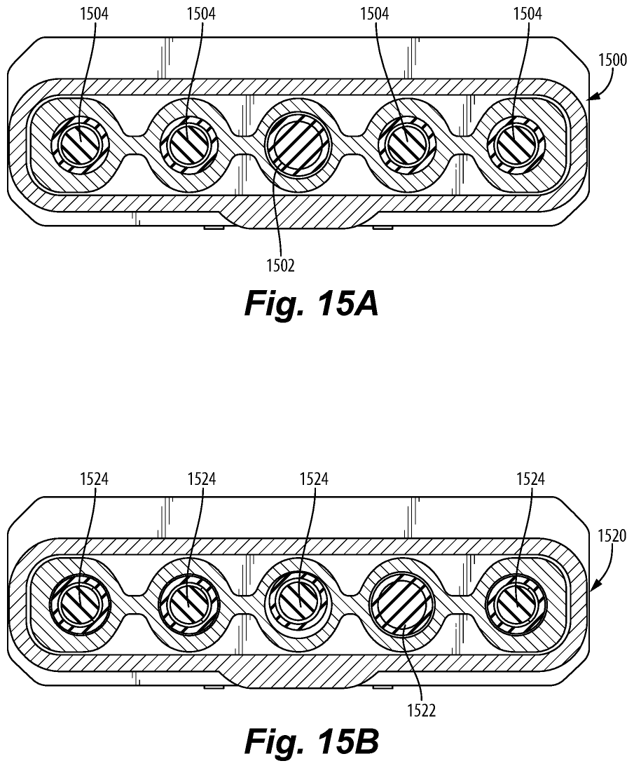

FIGS. 15A and 15B are front views of embodiments of male plugs of a high-current, relatively flat electrical connector illustrating different keying features. For instance, “keying” features refers to the concept of a design in which corresponding components (e.g., male and female portions) are configured to fit together in one way and prevents the mating in an incorrect orientation. Unique keying can be used in particular for multiple improved electrical configurations, such as the high-current applications described herein. FIG. 15A shows a “6:00” equivalent configuration 1500, where the larger ground conductor or pin 1502 is arranged in the middle of a five-conductor arrangement. It is to be appreciated that the other conductors or pins 1504 have a smaller diameter than pin 1502 and are of the same size. FIG. 15B shows a “7:00” equivalent configuration 1520, where the larger ground conductor or pin 1522 is the fourth in line of the five-conductor arrangement. Neutral and power pins are arranged in the other positions in the in-line configuration, e.g., conductors 1504 in FIG. 15A and conductors 1524 in FIG. 15B. Thus, different designs may include altering the ground (GND) pin position from a central position to an adjacent pin position. The enlarged GND pin diameter is configured to only engage in a designated GND sleeve position to thereby prevent inter-mating of unlike components. It is to be appreciated that the size and/or position of any one particular pin or sleeve, e.g. the ground pin or ground sleeve, may be selected to indicate a particular amperage and/or voltage. In this manner, a male plug having predetermined pin sizes and positions may only be coupled to a female connector having the corresponding size and position configuration. For example, connector 1500 may be configured as a 175 amp connector while connector 1520 may have a rating of 250 amps. These configurations are only exemplary and other possible configurations are contemplated to be within the scope of the present disclosure.

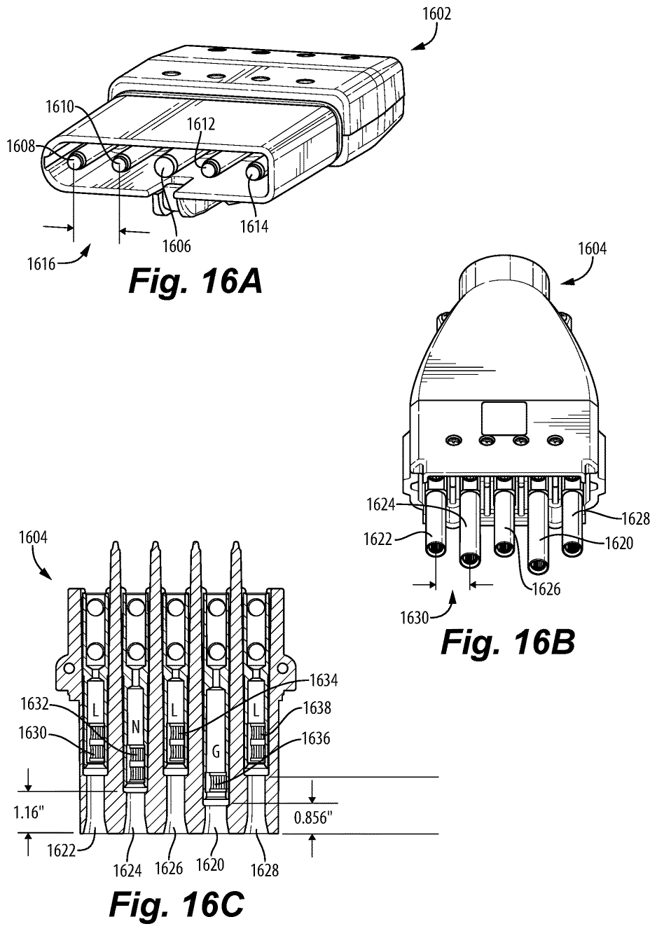

FIG. 16A is a perspective front view of an embodiment of a male plug of a high-current, relatively flat electrical connector. FIG. 16B is a top front view of an embodiment of a female receptable or connector of a high-current, relatively flat electrical connector adapted for connection with the male plug of FIG. 16A. FIG. 16C is a cross-sectional view of an embodiment of the female connector of FIG. 16B.

Again, with respect to high-power, high-current applications (e.g., electrical current rating ≥120 A), conventional pin and sleeve wiring devices are predominant for high current applications. In the embodiments described herein, the male component 1602 (FIG. 16A) and female component 1604 (FIG. 16B) include a design that is no longer constrained by standards (e.g., IEC60309-2). There are limited opportunities to optimize their design for high current rating together with a more compact size with respect to the conventional solutions. Therefore, the flat arrangement, as described herein, enables optimization of contact size, contact spacing, and heat dissipation. For example, referring to FIG. 16A, male connector 1602 includes a ground pin contact 1606 having a diameter of 0.472 inches and neutral and line pin contacts 1608, 1610, 1612, 1614 having a diameter of 0.394 inches. As further shown in FIG. 16A, contact spacing 1616 between each pin contact is 1.0 inch for optimization of heat dissipation. It is to be appreciated that the values provided are merely exemplary values and other values for contact size and contact spacing are contemplated to be within the scope of the present disclosure.

Similarly, referring to FIG. 16B, female connector 1604 includes a ground sleeve contact 1620 having a diameter of 0.629 inches and neutral and line sleeve contacts 1622, 1624, 1626, 1628 having a diameter of 0.59 inches. It is to be appreciated that the diameters of the sleeve contacts 1620, 1622, 1624, 1626, 1628 are dimensioned to receive corresponding pin contacts 1606, 1608, 1610, 1612, 1614. As further shown in FIG. 16B, contact spacing 1630 between each sleeve contact is 1.0 inch for optimization of heat dissipation. It is to be appreciated that the values provided are merely exemplary values and other values for contact size and contact spacing are contemplated to be within the scope of the present disclosure.

Additional separation between contacts and increased offset distance of the line sleeves from the end of the connector housing are configured to minimize arcing between adjacent contacts. Referring to FIG. 16C, a cross-sectional view of female connector 1604 illustrates offset distance between contacts. Each sleeve contact 1620, 1622, 1624, 1626, 1628 includes a corresponding spring contact 1630, 1632, 1634, 1636, 1638 respectively disposed herein. As shown in FIG. 16C, the spring contacts 1630, 1632, 1634, 1636, 1638 are offset from each other in the sleeves 1620, 1622, 1624, 1626, 1628 to minimize arcing. In addition, the extra spacing between contacts increases perimeter surface area for heat dissipation and minimizes radiation of heat between adjacent contacts.

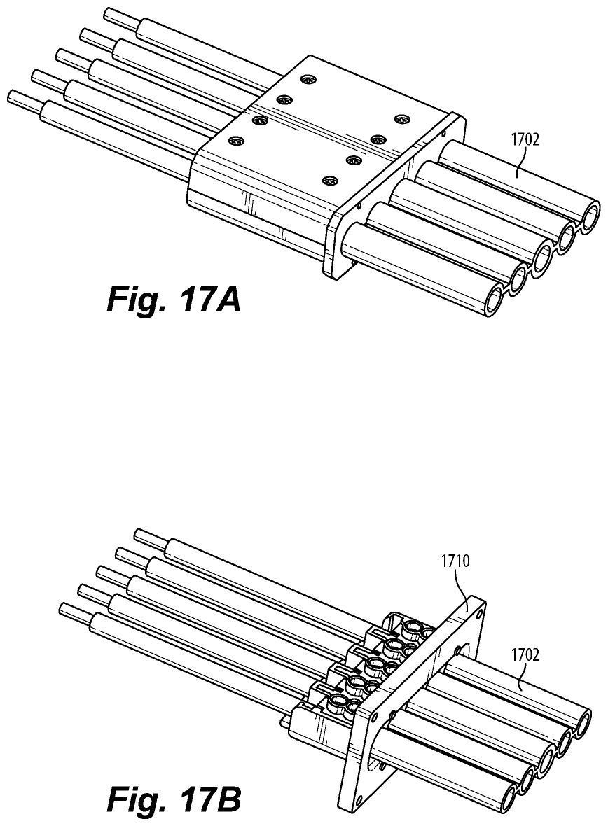

FIGS. 17A and 17B are perspective views of an embodiment of another strain relief assembly. The embodiments shown provide for a cord connector and panel mount designs that result in more optimal solutions. The connector design of the present embodiments includes strain relief rear housings for individual conductors, as shown in FIG. 17A. A panel mount design is configured to accommodate a flange 1710 for panel mounting, as shown in FIG. 17B. It is to be appreciated that the both connectors include a tube-like structure 1702 for retaining sleeves or receptacles where the structure electrically isolates the sleeves or receptacles from each other.

FIGS. 18A-G depict alternative configurations for electrical connectors for use in achieving various of the advantageous features of the present disclosure. With these embodiments, the connectivity devices use a pin-and-shoe configuration to facilitate mating and unmating of connectors 1800. In the embodiment depicted, as best shown in FIGS. 18A-B, a flat connector 1800 is exemplified but any geometrical configuration can be adapted for use with a pin-and-shoe mechanism. The connector 1800 includes a male portion 1801 and female portion 1802. The male portion 1801 comprises a housing 1803 having a generally rectangular bottom section 1805 and a narrow rectangular top section 1807. The bottom section 1805 includes four lateral line conductor receiving holes 1809, two on each side of the bottom section 1805 flanking the area outside of the narrow top section 1807. The narrow top section 1807 includes a ground conductor receiving hole 1811. The receiving holes 1809, 1811 are configured as terminals for receiving wires in need of electrical connection (not shown).

While the embodiment shown includes four line conductors for connection to respective conductor pins 1813, any amount or arrangement of conductors is within the scope of the present disclosure.

As best shown in FIGS. 18B-C, the bottom section 1805 includes laterally extending conductor pins 1813 or the type generally associated with pin-and-sleeve connectors. The top portion 1807 includes a bridge member 1815 formed as part of the housing that holds a laterally extending ground pin 1825. In some forms, the ground pin 1825 extends beyond the length of the conductor pins 1813 to ensure that any lateral movement of the male portion 1801 necessitates that the ground pin 1825 engages the female portion 1802 before any of the conductor pins 1813.

The bridge member 1815 includes finger extensions 1817 disposed on each side of the ground pin 1825. The finger extensions 1817 include a flat lateral portion 1819 and a ramp portion 1821. The significance of the ramp portion 1821 of these embodiments will be elaborated on below.

As best shown in FIG. 18E, the female portion 1802 includes a housing 1804 having an upper portion 1806 and a lower portion 1808. The lower portion 1808 includes female receptacle openings 1812 sized and configured for receiving the conductor pins 1813 of the male portion 1801. The openings 1810 are larger than typical pin receiving openings and in the depicted embodiment are configured as curved cradles conductors with an open top comprising conductor shoes 1810. The upper portion 1806 includes a vertically movable carriage portion 1820 imbedded in and internally movable relative to the housing 1804 in the direction of the female conductor shoes 1810. The carriage portion 1820 defines a centrally located ground pin receiving opening 1822 and a pair of finger receiving openings 1824 on each side of the ground opening 1822. The ground opening 1822 and finger receiving openings 1824 are located in a position that mirrors the location of the ground pin 1825 and finger extensions 1817 of the bridge member 1825 of the male connector portion 1801.

Carriage portion 1820 in the depicted embodiment includes an upper bridge portion 1832 having a ground pin receptacle 1834 provided therein and a bottom section 1836 having right and left flange 1842, 1844 on the distal ends of the carriage 1820. Also defined by the carriage 1820 are downwardly extending conductor teeth 1846 having curved ends 1848 sized to encircle a top half of a conductor pin 1813 when in use.

The carriage 1820 is spring biased away from the line conductor shoes via spring members 1850 positioned in the lower portion 1808 of the housing 1804 biasing against the right and left flanges 1842, 1844. In a presently preferred embodiment, the lower portion 1808 includes four spring members 1850, two under each flange 1842, 1844 and spaced to prevent binding and non-uniform movement of the carriage 1820.

In operation, as shown in FIG. 18C, when a connection is desired, the male portion 1801 is positioned and laterally moved to allow the ground pin 1825 to enter the ground opening 1822 on the female portion 1802. Additional laterally movement will allow the fingers 1817 to laterally proceed into the finger receiving openings 1824. The cooperative shape of the carriage's finger receiving openings 1824 having its own ramp member 1860 therein results in the ramp portion 1821 of the finger extensions 1817 engaging the carriage's inner ramp 1860 to create a downward camming force as the ingress of the ramp and the lateral force applied overcomes the spring bias of the carriage 1820 to force it vertically downward.

At the same time, the conductor pins 1813 are entering the pin receiving holes 1808 and are seated in the shoe contacts 1810. Continued lateral insertion of the male portion 1801 and camming action of the ramps forces the carriage 1820 further downward until the conductor teeth engage the conductor pins 1813 and form a secure electrical and mechanical connection of the pins 1813 in the shoes 1810. As will be appreciated by one of ordinary skill in the art armed with the present specification, this configuration operates in a manner similar to a drum brake system. While there will be some sliding friction on the engaging ramp surfaces, the overall insertion force is low. As will also be appreciated, the cooperating ramps are sized and positioned to insure full insertion of the pins and environmentally isolated connection of the connector is completed and the carriage is held relatively tightly against the conductor pins.

In operation, to disconnect the connector 1800, a force sufficient to overcome the holding force of the compressed springs 1850 is applied to remove the ramp of the male member 1801 and allow the springs 1850 to bias the carriage 1820 open and allow the connector ends 1801, 1802 to separate with minimal effort.

One of ordinary skill in the art should readily appreciate that while the embodiment depicted for descriptive purposes comprises a linear pin arrangement, any geometric configuration of the connector and/or pins should be understood to be within the scope of the present disclosure. For example, as shown in FIG. 19, a round connector 1900 may be configured with a pin-and-shoe assembly. In this embodiment, the female connector 1902 includes a circular pattern of pin receptacles 1975 disposed on the periphery of the connector sleeve body. Each of these pin receptacles is equipped with shoe contacts 1910 for receipt of corresponding pins of the male connector portion (not shown). It is to be appreciated that the shoe contacts 1910 may include half-round spring elements as described above in relation to FIGS. 4G and 4H.

To close the shoes 1910 a radially expanding pressure on the carriage 1920 is required to expand the carriage 1920 from inwards to outwards in order to force the carriage teeth to close on the connector pins. In order to move the carriage radially outward, the carriage is configured as an expandable sleeve with a central bore 1970. The central bore 1970 is adapted to receive a central extension 1980 from the male connector. Upon insertion, an immediate or gradual expansion (via a taper) forces the radially expanding carriage outwardly until the contacts are closed.

Any known method to insure proper insertion of the male portion may be used in a given construction. For example, the pin openings and pins may be in a specific pattern ensuring only a single mirror image configuration for mating. Likewise, the central bore and/or pin openings may be keyed to match a profile of the central extension of the male connector.

One of ordinary skill in the art armed with the present specification will readily appreciate that the exemplary pin-and-sleeve embodiments described above were provided for explanatory purposes and are not to be interpreted as limiting the present disclosure to any of the specific features, combinations, configurations, form factors, or other limitations described in connection with the embodiments depicted in the figures. It is to be appreciated that the various features shown and described are interchangeable, that is a feature shown in one embodiment may be incorporated into another embodiment.

For example, in various embodiments, the novel form factors, novel male and female contact configurations, novel contact materials and thermal management techniques enable pin-and-sleeve connectors to be configured with a high amperage rating, e.g., at least 175 amps, while having a flat form factor compared to conventional round pin-and-sleeve connectors having a comparable amperage rating.

Any known method to ensure proper insertion of the male portion may be used in a given construction. For example, the pin openings and pins may be in a specific pattern ensuring only a single mirror image configuration for mating. Likewise, the central bore and/or pin openings may be keyed to match a profile of the central extension of the male connector.

While not shown in the various exemplary embodiments, the connectors disclosed herein may be provided with other mechanical friction connections or the like to visually or audibly ensure a full connection, and/or prevent inadvertent disconnection, and/or lock connectors in a closed position.

One of ordinary skill will appreciate that the exact dimensions and materials are not critical to the disclosure and all suitable variations should be deemed to be within the scope of the disclosure if deemed suitable for carrying out the objects of the disclosure.

One of ordinary skill in the art will also readily appreciate that it is well within the ability of the ordinarily skilled artisan to modify one or more of the constituent parts for carrying out the various embodiments of the disclosure. Once armed with the present specification, routine experimentation is all that is needed to determine adjustments and modifications that will carry out the present disclosure.

The above embodiments are for illustrative purposes and are not intended to limit the scope of the disclosure or the adaptation of the features described herein to particular electrical connectors. Those skilled in the art will also appreciate that various adaptations and modifications of the above-described preferred embodiments can be configured without departing from the scope and spirit of the disclosure. Therefore, it is to be understood that, within the scope of the appended claims, the invention may be practiced other than as specifically described.

What is claimed:

1. An electrical connector comprising:
a male connector having multiple conductor pins, the multiple conductor pins being arranged in a substantially linear configuration, wherein the multiple conductor pins of the male plug include one ground conductor pin, one neutral conductor pin, and three hot conductor pins;
a female connector having multiple receptacles configured to receive the multiple conductor pins of the male connector;
a latching assembly configured to secure the male connector to the female connector, the latching assembly including a latch member having a latch handle and a curved groove; and
a plurality of individual conductors, an individual conductor extending from each of the multiple conductor pins of the male connector.

2. The electrical connector of claim 1, wherein the latching assembly includes a cylindrical pin configured to be engaged by the curved groove.

3. The electrical connector of claim 2, wherein the latching assembly is configured to provide a closing force to pull the male connector and the female connector together.

4. The electrical connector of claim 1, wherein a position of the ground conductor pin prevents intermating of the male plug to a female connector with a different electrical rating.

5. The electrical connector of claim 1, further comprising silver plating in at least one of the male connector or the female connector.

6. The electrical connector of claim 1, wherein the male connector includes a first cover portion and a second cover portion releasably connected to the first cover portion.

7. The electrical connector of claim 6, wherein the first cover portion includes a snap-fit connection to the second cover portion.

8. The electrical connector of claim 6, wherein the second cover portion is pivotally connected to the second cover portion.

9. The electrical connector of claim 1, wherein the male connector or the female connector includes an alignment rib configured to configured to prevent improper mating of the male connector with the female connector.

10. An electrical connector comprising:
a male connector having multiple conductor pins, the multiple conductor pins being arranged in a substantially linear configuration;
a female connector having multiple receptacles configured to receive the multiple conductor pins of the male connector;
a latching assembly configured to secure the male connector to the female connector; and
a plurality of individual conductors, an individual conductor extending from each of the multiple conductor pins of the male connector,
wherein the male connector and the female connector include an alignment interface configured to prevent improper mating of the male connector with the female connector.

11. The electrical connector of claim 10, wherein alignment interface includes a rib and a slot configured to receive the rib.

12. The electrical connector of claim 11, wherein the rib extends from adjacent one of the multiple receptacles on the female connector.

13. The electrical connector of claim 10, wherein the electrical connector is configured to carry a high current of at least 175 Amps.

14. The electrical connector of claim 10, wherein the latching assembly includes a latch handle and a latch pin.

15. The electrical connector of claim 10, wherein the male connector includes a first cover portion and a second cover portion releasably connected to the first cover portion.

16. An electrical connector comprising:
a male connector having a ground conductor pin, a neutral conductor pin, and three hot conductor pins arranged in a substantially linear configuration;
a female connector having a ground conductor receptacle, a neutral conductor receptacle, and three hot conductor receptacles; and
a latching assembly configured to secure the male connector to the female connector, the latching assembly including a pivoting latch member having a latch handle and a cam surface configured to engage a pin; and
wherein the male connector and the female connector including an alignment interface configured to prevent improper mating of the male connector with the female connector, the alignment interface including at least one alignment rib.

17. The electrical connector of claim 16, wherein the male connector includes a strain relief member.

18. The electrical connector of claim 16, wherein the cam surface pulls the male connector and the female connector together during a latching operation.

19. The electrical connector of claim 16, wherein the male connector includes a first cover portion and a second cover portion snap-fit to the first cover portion.

20. The electrical connector of claim 16, wherein the latch member is pivotally connected to the female connector.
